(19) United States
(12) Patent Application Publication
(10) Pub. No.: US 2026/0243990 A1
(43) Pub. Date: Aug. 20, 2026

(54) TELECOMMUNICATION ENCLOSURES

(71) Applicant: AFL Telecommunications LLC, Duncan, SC (US)

(72) Inventors: Eddie Kimbrell, Dacula, GA (US); Tyler Clas, Duncan, SC (US)

(21) Appl. No.: 18/992,361

(22) PCT Filed: Jul. 7, 2023
(86) PCT No.: PCT/US2023/027121

§ 371 Date: Jan. 8, 2025

Related U.S. Application Data
(60) Provisional application No. 63/359,549, filed on Jul. 8, 2022.
(60) Provisional application No. 63/446,963, filed on Feb. 20, 2023.
(60) Provisional application No. 63/447,195, filed on Feb. 21, 2023.

(51) Int. Cl. G02B 6/44

(52) U.S. Cl. CPC G02B 6/44775

(57) ABSTRACT

A sealing structure includes a first body defining a plurality of cutouts; and a plurality of second bodies, each of the plurality of second bodies disposed in one of the plurality of cutouts, wherein each of the second bodies comprises: a first half including a sealing member disposed between a first end plate and a second end plate; and a second half including a sealing member disposed between a first end plate and a second end plate, wherein the sealing member of a first half of one second body abuts the sealing member of a second half of another second body, and wherein each of the plurality of second bodies is configured to seal a fiber optic cable entering or exiting the enclosure.

### CROSS-REFERENCE TO RELATED APPLICATIONS

The present application is a national stage of PCT/US2023/027121 filed on Jul. 7, 2023, which claims priority to U.S. Provisional Patent Application 63/359,549 filed on Jul. 8, 2022, U.S. Provisional Patent Application 63/446,963 filed on Feb. 20, 2023, and U.S. Provisional Patent Application 63/447,195 filed on Feb. 21, 2023, the disclosures of which is incorporated by reference herein in their entireties.

### FIELD

The present disclosure relates generally to telecommunication enclosures, and more particularly to telecommunication enclosures for optical fiber networks.

### BACKGROUND

Optical fiber networks utilize optical fibers extending between two or more endpoints to transmit data between the two or more endpoints. These endpoints may be located at service providers, houses, office buildings, venues, wireless transmission devices, or a number of other locations. Data is transmitted through the optical fibers, typically in both directions, between the endpoints using optical signals. Data transmission requires continuous passage of the optical signals through the optical fibers. Any interruption or unexpectedly large loss of signal can result in one or more endpoints failing to receive the data.

Since optical fiber networks include several endpoints all interconnected together and located remote from one another, it is typically necessary to introduce multiple optical fibers to complete the optical fiber network. These multiple fibers are joined together at splices and other connection locations to transmit optical signals through the optical fiber network. Typically, connection locations are protected from harsh environmental elements. Enclosures allow for termination or joining of fibers, such as drop fibers, while protected the connection locations from the environmental elements. However, enclosures are only as good as their sealing characteristics. Many enclosures on the market are either poor at sealing or fail to offer sufficient adjustability to allow for use of a wide range of optical fibers in the network.

Accordingly, improved enclosures are desired in the art. In particular, enclosures which provide good sealing characteristics and adjustability would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a sealing structure for an enclosure is provided. The sealing structure includes a first body defining a plurality of cutouts; and a plurality of second bodies, each of the plurality of second bodies disposed in one of the plurality of cutouts, wherein each of the second bodies comprises: a first half including a sealing member disposed between a first end plate and a second end plate; and a second half including a sealing member disposed between a first end plate and a second end plate, wherein the sealing member of a first half of one second body abuts the sealing member of a second half of another second body, and wherein each of the plurality of second bodies is configured to seal a fiber optic cable entering or exiting the enclosure.

In accordance with another embodiment, a sealing structure is provided. The sealing structure includes a first end plate; a second end plate; and a sealing member disposed between the first and second end plates, wherein at least one of the first and second end plates comprises a wall having a first side, a second side, and an opening extending between the first and second sides, wherein the sealing member extends through the opening from the first side of the wall to a channel disposed in a second side of the wall so as to fill the channel, and wherein the sealing member is fixedly coupled to the wall by the portion of the sealing member extending through the opening and into the channel.

In accordance with another embodiment, a method of sealing an enclosure receiving a fiber optic cable is provided. The method includes forming a sealing structure, wherein forming the sealing structure is performed by: providing a first body; forming a second body configured to receive the fiber optic cable, wherein forming the second body comprises translating a first half of the second body and a second half of the second body together; and inserting the second body into a receiving area of the first body; inserting the sealing structure into a housing of the enclosure; and closing a cover of the enclosure to compress the sealing structure and seal the fiber optic cable.

In accordance with another embodiment, a sealing structure for an enclosure receiving a fiber optic cable is provided. The sealing structure includes a first body comprising a pair of fingers defining a slot; a second body disposed at the slot and defining a cutout to receive the fiber optic cable within the cutout; a plug insertable into the cutout when the fiber optic cable is not present in the cutout, wherein the plug comprises: a first member; a second member; and a third member disposed between the first and second members, wherein the first, second and third members are separable from one another, and wherein an effective diameter of the plug is selectable based on which of the first, second and third members are present.

In accordance with another embodiment, a method of sealing a cutout in a sealing system for an enclosure configured to receive a fiber optic cable when the fiber optic cable is less than an entire dimension of the cutout is provided. The method includes determining a size of the fiber optic cable to be received in the cutout; configuring a plug between two or more different states in view of the determined size, each state being associated with a different cross-sectional size of the plug; installing the plug in the cutout with the fiber optic cable; and closing the enclosure to seal the cutout around the fiber optic cable.

In accordance with another embodiment, a sealing structure for an enclosure receiving a fiber optic cable is provided. The sealing structure includes a first body defining a cutout; a second body receivable in the cutout, wherein the second body comprises a first end plate, a second end plate, and a sealing member disposed between the first and second endplates; and a user engageable element configured to selectively bias the first and second end plates together when the user engageable element is threaded to the cutout at a threaded interface.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a perspective view of an enclosure for one or more components of an optical fiber network in accordance with embodiments of the present disclosure;

FIG. 2 is a rear view of the enclosure in accordance with embodiments of the present disclosure;

FIG. 3 is a perspective view of an inside of a housing of the enclosure in accordance with embodiments of the present disclosure;

FIG. 4 is a perspective view of a cover of the enclosure in accordance with embodiments of the present disclosure as seen with the cover in a closed configuration;

FIG. 5 is a perspective view of the cover of the enclosure as seen in FIG. 4 in accordance with embodiments of the present disclosure as seen with the cover in a semi-open configuration;

FIG. 6 is a perspective view of a cover of the enclosure in accordance with embodiments of the present disclosure;

FIG. 7 is a perspective view of an internal portion of the enclosure as seen with the cover removed in accordance with embodiments of the present disclosure;

FIG. 8 is a perspective view of a drop compartment tray in accordance with embodiments of the present disclosure;

FIG. 9 is a perspective view of a sealing assembly of the enclosure in accordance with embodiments of the present disclosure from an external view of the enclosure;

FIG. 10 is a perspective view of the sealing assembly of FIG. 9 in accordance with embodiments of the present disclosure from an internal view of the enclosure;

FIG. 11 is a perspective view of a plug in accordance with embodiments of the present disclosure;

FIG. 12 is a perspective view of a member of the plug in accordance with embodiments of the present disclosure;

FIG. 13 is a perspective view of another member of the plug in accordance with embodiments of the present disclosure;

FIG. 14 is a perspective view of yet another member of the plug in accordance with embodiments of the present disclosure;

FIG. 15 is a perspective view of a sealing system for the enclosure in accordance with embodiments of the present disclosure when the sealing system is housing a first cable;

FIG. 16 is a bottom view of the sealing system in accordance with embodiments of the present disclosure when the sealing system is housing the first cable;

FIG. 17 is a perspective view of a sealing system for the enclosure in accordance with embodiments of the present disclosure when the sealing system is housing a second cable;

FIG. 18 is a bottom view of the sealing system in accordance with embodiments of the present disclosure when the sealing system is housing the second cable;

FIG. 19 is a perspective view of a sealing system for the enclosure in accordance with embodiments of the present disclosure when the sealing system is housing a third cable;

FIG. 20 is a bottom view of the sealing system in accordance with embodiments of the present disclosure when the sealing system is housing the third cable;

FIG. 21 is a perspective view of an enclosure in accordance with embodiments of the present disclosure as seen with a cover of the enclosure in a closed configuration;

FIG. 22 is a perspective view of the enclosure in accordance with embodiments of the present disclosure as seen with the cover in a semi-open configuration;

FIG. 23 is a perspective view of the enclosure in accordance with embodiments of the present disclosure with the sealing system being introduced to the enclosure;

FIG. 24 is a perspective view of the enclosure in accordance with embodiments of the present disclosure with the sealing system installed within the enclosure;

FIG. 25 is a perspective view of a second body of the sealing system in accordance with embodiments of the present disclosure as seen with a first half and a second half of the second body separated from one another;

FIG. 26 is a perspective view of the second body of the sealing system in accordance with embodiments of the present disclosure as seen with the first half and the second half of the second body being introduced together;

FIG. 27 is a perspective view of the assembled second body in accordance with embodiments of the present disclosure;

FIG. 28 is a perspective view of a first end plate associated with the second body in accordance with embodiments of the present disclosure;

FIG. 29 is a perspective view of the first end plate associated with the second body in accordance with embodiments of the present disclosure;

FIG. 30 is a perspective view of a second end plate associated with the second body in accordance with embodiments of the present disclosure;

FIG. 31 is a perspective view of the second end plate associated with the second body in accordance with embodiments of the present disclosure;

FIG. 32 is a perspective view of a sealing system in accordance with embodiments of the present disclosure;

FIG. 33 is a perspective view of a portion of the sealing system in accordance with embodiments of the present disclosure;

FIG. 34 is a perspective view of a portion of the sealing system in accordance with embodiments of the present disclosure;

FIG. 35 is a perspective view of the sealing system in accordance with embodiments of the present disclosure;

FIG. 36 is a perspective view of a portion of the sealing system in accordance with embodiments of the present disclosure;

FIG. 37 is a perspective view of a sealing system in accordance with embodiments of the present disclosure;

FIG. 38 is a perspective view of components of the sealing system in accordance with embodiments of the present disclosure;

FIG. 39 is a cross-sectional side view of a second body of the sealing system in accordance with embodiments of the present disclosure;

FIG. 40 is a perspective view of the components of the sealing system in accordance with embodiments of the present disclosure as seen with a user engageable element prior to installation;

FIG. 41 is a perspective view of the components of the sealing system in accordance with embodiments of the present disclosure as seen with the user engageable element during installation;

FIG. 42 is a perspective view of the components of the sealing system in accordance with embodiments of the present disclosure as seen with the suer engageable element after installation;

FIG. 43 is a perspective view of the sealing system in accordance with embodiments of the present disclosure as seen during assembly;

FIG. 44 is a perspective view of the sealing system in accordance with embodiments of the present disclosure as seen during assembly;

FIG. 45 is a perspective view of the sealing system in accordance with embodiments of the present disclosure as seen during assembly;

FIG. 46 is a perspective view of the sealing system in accordance with embodiments of the present disclosure as seen during assembly;

FIG. 47 is a cross-sectional side view of the sealing system in accordance with embodiments of the present disclosure as seen along Line A-A in FIG. 46;

FIG. 48 is an exploded perspective view of a sealing system in accordance with embodiments of the present disclosure;

FIG. 49 is a perspective view of the sealing system in accordance with embodiments of the present disclosure;

FIG. 50 is a cross-sectional view of the sealing system in accordance with embodiments of the present disclosure;

FIG. 51 is a perspective view of a sealing system in accordance with embodiments of the present disclosure;

FIG. 52 is a perspective view of a sealing system in accordance with embodiments of the present disclosure;

FIG. 53 is a partially exploded view of a portion of the sealing system in accordance with embodiments of the present disclosure;

FIG. 54 is a perspective view of a sealing assembly for the sealing system in accordance with embodiments of the present disclosure;

FIG. 55 an exploded perspective view of the sealing system in accordance with embodiments of the present disclosure; and

FIG. 56 is an exploded perspective view of a portion of the sealing system in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises.” “comprising,” “includes,” “including,”has,“having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, enclosures for optical networks described in accordance with one or more embodiments herein can be utilized to protect optical components and spliced connections between optical fibers and any or all related optical components associated therewith. Part of this protection can include mitigation of exposure to environmental elements which might otherwise degrade the optical components, the fibers, or both, thereby reducing signal transmissibility therethrough.

Enclosures described herein can define different areas each accessible by different means. Each area can be accessed by a different technician at a different time, e.g., during a different installation or servicing operation. For example, a first area of the enclosure can be accessed during initial installation and wiring of the enclosure and a second area different than the first area can be accessed during follow up wiring operations where network endpoints are optically coupled to the optical network. The technicians associated with the initial installation and the follow up wiring operation can be different from each other and have different skill levels relative to one another. For example, the technician associated with the initial installation can have a relatively high technical acumen while the technician associated with the follow up wiring operation can have a relatively low technical acumen by comparison. By separating the first and second areas from one another, access to more technical aspects of the enclosure housed in the first area can be limited to the technician with the higher technical acumen while access to the second area can be reserved for the lower skilled technician or accessible by both the lower and higher skilled technicians.

One or more different areas of the enclosure described herein may be sealed using a sealing structure. Various sealing structures and their associated components are described below.

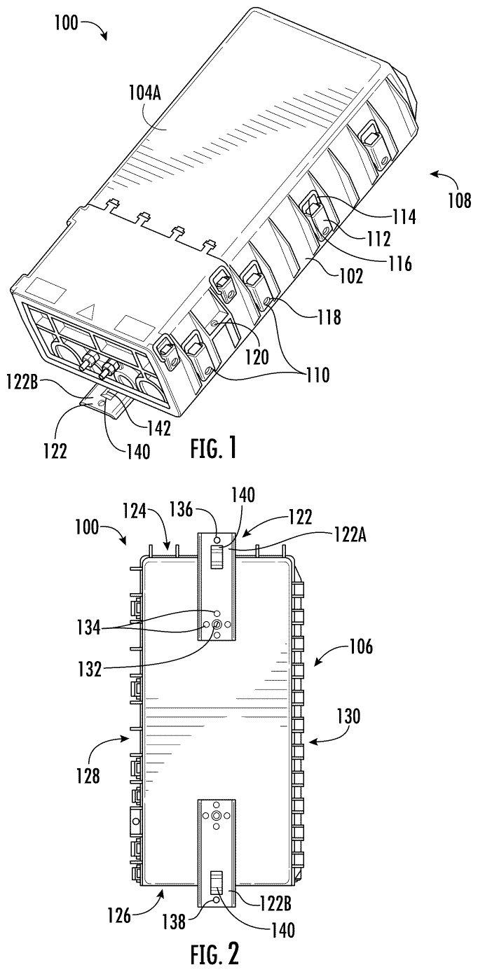

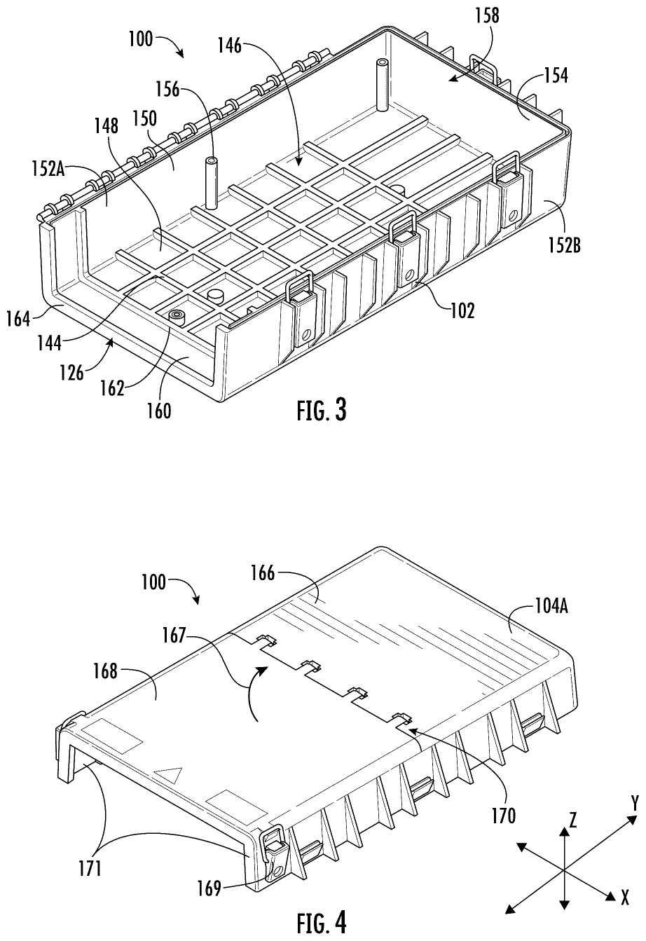

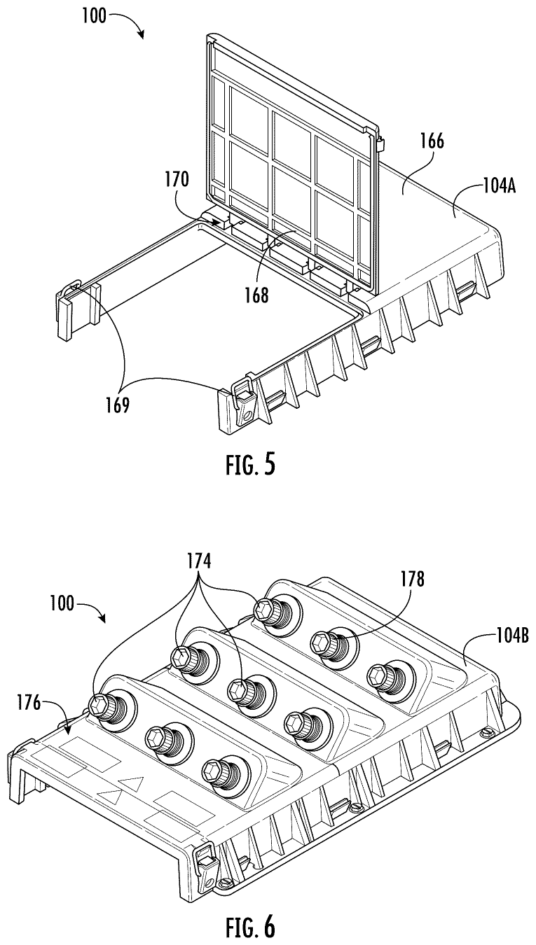

Referring now to the drawings, FIGS. 1 to 7 illustrate an enclosure 100 and various parts of the enclosure 100 in accordance with exemplary embodiments. In particular, FIG. 1 illustrates a front perspective view of the enclosure 100, FIG. 2 illustrates a rear view of the enclosure 100, FIG. 3 illustrates a front perspective view of a housing 102 of the enclosure 100, FIG. 4 illustrates a front perspective view of a cover 104A of the enclosure 100 as seen in a closed configuration, FIG. 5 illustrates a front perspective view of the cover 104A as seen in a semi-open configuration, FIG. 6 illustrates a front perspective view of a cover 104B of the enclosure 100 in accordance with another embodiment, and FIG. 7 illustrates a front perspective view of the housing 102 of the enclosure 100 with at least some components to be housed in the enclosure 100 disposed therein.

The enclosure 100 can be used in an optical fiber network to protect various optical fiber network components (hereinafter referred to as “components”) from environmental elements such as rain, sleet, snow, hail, wind, falling branches, dust, UV rays, animals, and the like. The components can be used to route and connect optical fibers to allow for transmission of data through the optical fiber network.

The enclosure 100 can generally define a hardened shell in which the components and optical fiber connection locations can be protected from the environmental elements. In some instances, the enclosure 100 can define a shallow receiving area for receiving the components and optical fiber connection locations.

The shallow receiving area can have a dimension, as measured between the housing 102 and the cover 104A, of less than 5 inches, such as less than 4 inches, such as less than 3 inches. In other instances, the enclosure 100 can define a deep receiving area for receiving the components and optical fiber connection locations. The deep receiving area can have a dimension, as measured between the housing 102 and the cover 104A, of at least 5 inches, such as at least 5.5 inches, such as at least 6 inches, such as at least 6.5 inches.

With the enclosure 100 disposed in the state depicted in FIG. 1, the components can be protected from the environmental elements. The enclosure 100 can be selectively entered by a technician to access to the components or portions of the optical fibers disposed within the enclosure 100. For example, the enclosure 100 can include the aforementioned housing 102 and cover 104A which can be selectively moveable relative to one another to allow access to an interior of the enclosure 100. By way of non-limiting example, the housing 102 and cover 104A may be pivotally coupled together through a hinged interface 106 (FIG. 2). The hinged interface 106 can allow the cover 104A to swing relative to the housing 102 between an open configuration (not illustrated) and a closed configuration (FIG. 1). A latch system 108 can be disposed opposite the hinged interface 106 to retain the cover 104A in the closed configuration.

In an embodiment, the latch system 108 can include a plurality of latches 110, e.g., coupled to the housing 102. The latches 110 can each include a user engagement element 112 operably coupled to an interfacing component 114. The interfacing components 114 can each extend from the housing 102 towards the cover 104A and interface with a complementary interfacing component 116 disposed on the cover 104A. By way of non-limiting example, the complementary interfacing component 116 can be a ridge or channel in which a shaped wire or other shaped feature of the interfacing component 114 can be selectively engaged with. A seal (not illustrated) disposed between the housing 102 and the cover 104A may form an interference between the housing 102 and the cover 104A to prevent the cover 104 from fully moving to the closed configuration. To fully close the cover 104A, the interfacing components 114 of the housing 102 can be aligned relative to the complementary interfacing components 116 of the cover 104A and the user engagement elements 112 can be biased to pull the cover 104 towards the housing 102. In an embodiment, at least one of the user engagement elements 112 can include a locking feature to lock the cover 104A in the closed configuration. The locking feature can include, for example, an opening 118 extending through the user engagement element 112 to receive a lock (not illustrated). The lock can pass through the user engagement element 112 and a secondary feature of the housing (such as a secondary opening disposed between the user engagement element 112 and a sidewall of the housing 102) to lock the enclosure 100 in the closed configuration.

Alternatively, or in addition to the opening 118, an opening 120 can be formed directly in each of the housing 102 and the cover 104A such that a lock (not illustrated) can pass through the complementary openings 120 to lock the enclosure 100 in the closed configuration.

The enclosure 100 can include a mounting feature 122 to mount the enclosure 100 to a nearby environmental fixture, such as a utility pole, a fence, a wall, a building, or the like. Referring to FIG. 2, the mounting feature 122 can include a plurality of components, such as a first mounting feature 122A and a second mounting feature 122B. The first and second mounting features 122A and 122B can be spaced apart from one another. For example, the first mounting feature 122A can be disposed adjacent to a first side 124 of the enclosure 100 and the second mounting feature 122B can be disposed adjacent to a second side 126 of the enclosure. The first side 124 can form a top side of the enclosure 100 and the second side 126 can form a bottom side of the enclosure 100. Alternatively, the first mounting feature 122A can be disposed on a first lateral side 128 of the enclosure 100 and the second mounting feature 122B can be disposed on a second lateral side 130 of the enclosure 100. The first and second mounting features 122A and 122B can be arranged in yet alternative positions with respect to one another and the enclosure 100. The first and second mounting features 122A and 122B can be rotated, e.g., 90 degrees, to mount the enclosure in other types of installations, e.g., wire messenger installations, vault installations, and for other mounting structure.

In an embodiment, the mounting features 122A and 122B can each be coupled to the housing 102 through one or more fasteners 132. The one or more fasteners 132 can include, for example, a threaded fastener, a non-threaded fastener, a bayonet connection, a crimped connection, an adhesive-based connection, another suitable connection interface, or any combination thereof. At least one of the mounting features 122A and 122B can include an anti-rotation feature to prevent rotation relative to the housing 102. By way of non-limiting example, the anti-rotation feature can include dimples 134 which interface with complementary features (not illustrated) on the housing 102 to rotationally key the mounting feature(s) 122A and 122B relative to the housing 102.

In an embodiment, the first mounting feature 122A can extend past the first side 124 of the enclosure 100 such that an engagement feature 136 of the first mounting feature 122A is exposed when the enclosure 100 is positioned against the nearby environmental fixture. The engagement feature 136 can be used to mount the enclosure 100 relative to the nearby environmental fixture. The engagement feature 136 can include, for example, an opening configured to receive a fastener which can be coupled to the nearby environmental fixture. In another embodiment, the second mounting feature 122B can extend past the second side 126 of the enclosure 100 such that an engagement feature 138 of the second mounting feature 122B is exposed when the enclosure 100 is positioned against the nearby environmental feature. The engagement feature 138 can share any one or more attributes or characteristics as compared to first engagement feature 136. For example, the engagement feature 138 can include an opening configured to receive a fastener which can be coupled to the nearby environmental fixture.

A strap receiving feature 140 may be included on at least one of the mounting features 122A or 122B to allow the enclosure 100 to be mounted to the nearby environmental feature using a strap, a cable, or the like. The strap receiving feature 140 can define a passthrough 142 (FIG. 1) through which a strap (not illustrated) can be passed. When wrapped around the nearby environmental fixture and through the passthrough 142, the strap can secure the enclosure 100 to the fixture. In some instances, the strap receiving feature 140 and at least one of the engagement features 136 and 138 can be used simultaneously. That is, the enclosure 100 can be coupled to the nearby environmental fixture using both a strap and a fastener. In another embodiment, the strap receiving feature 140 can be used for some installations (e.g., utility pole mounting) and the engagement feature(s) 136 or 138 can be used for other installations (e.g., wall mountings).

FIG. 3 illustrates an internal view of the housing 102 as seen in accordance with an exemplary embodiment. Ribs 144 can extend along a first portion 146 of a rear wall 148 of the housing 102. The ribs 144 can be arranged in a matrix, such as for example, a gridded pattern. The ribs 144 can increase the strength of the housing 102 to allow for thinner walls and thereby an overall reduced weight of the enclosure 100. A sidewall 150 can extend outward from the rear wall 148. The sidewall 150 can include opposite lateral walls 152A and 152B and a top wall 154. The lateral walls 152A and 152B can be joined with the top wall 154 to form a continuous sidewall 150 or the lateral walls 152A and 152B can be unitary with the top wall 154 (i.e., formed from a single piece construction). A plurality of supports 156 can extend from the rear wall 148 in a direction towards an open front end 158 of the housing 102. The supports 156 can support internal structure of the enclosure 100 as described below.

A second portion 160 of the housing 102 can be disposed adjacent to the first portion 146. The second portion 160 can be separated from the first portion 146 by a first flange 162. The first flange 162 can be integral with and extend from the rear wall 148 of the housing 102 towards the open front end 158. The first flange 162 can also extend from the opposite lateral sidewalls 152A and 152B. In an embodiment, the first flange 162 can be contiguous with the ribs 144 to increase strength of the first flange 162. The second portion 160 of the housing 102 can be further defined by a second flange 164. The second flange 164 can be disposed adjacent, such as immediately adjacent, to the second side 126 of the enclosure 100. The second portion 160, as defined by the first and second flanges 162 and 164 can have a relatively smooth surface profile. By way of non-limiting example, the relatively smooth surface profile can be free of ribs, undulations, dimples, surface texture, or the like. The second portion 160 can receive a sealing structure as described below.

FIGS. 4 and 5 illustrate the cover 104A for use with the enclosure 100 in accordance with an exemplary embodiment. More particularly, FIG. 4 illustrates the cover 104A in a closed configuration and FIG. 5 illustrates the cover 104A in a semi-open configuration. The cover 104A is a multi-component structure including, e.g., a first cover portion 166 and a second cover portion 168. The first and second cover portions 166 and 168 can be moveable with respect to one another. For instance, the second cover portion 168 can be pivotably coupled to the first cover portion 166 at a hinged interface 170. The second cover portion 168 can be moved about the hinged interface 170 between the closed position (as illustrated in FIG. 4) and the open position (as illustrated in FIG. 5 and also referred to as the semi-open configuration). To move the cover 104A to a fully open configuration, the cover 104A is pivoted about the hinged interface 106 (FIG. 2) such that both the first and second cover portions 166 and 168 are clear of the open front end 158 (FIG. 3) of the housing 102. This can be performed with the second cover portion 168 in either the semi-open or closed configurations.

Referring to FIG. 4, the cover 104A can move between the open and closed configurations by rotating about the Y-axis. Closing the cover 104A can be performed by clockwise rotation of the cover 104A about the Y-axis. Opening the cover 104A can be performed by counter-clockwise rotation of the cover 104A about the Y-axis. The second cover portion 168 can be moved between the closed and semi-open configurations by rotating the second cover portion 168 about the X-axis. Thus, moving the cover 104A between the closed and semi-open configurations can be performed by moving portions of the cover (e.g., at least one of the first or second cover portions 166 or 168) about a first axis and moving the cover 104A between the closed or semi-open configuration and the open configuration can be performed by moving the cover 104A about a second axis angularly offset from the first axis. The first and second axis can be oriented perpendicular to one another. Alternatively, the first and second axis can be offset by another relative angle, such as between 15° and 75°, such as between 20° and 70°, such as between 25° and 65°, such as between 30° and 60°. In an embodiment, the second cover portion 168 can rotate in an upward direction as shown by arrow 167. In this regard, the second cover portion 168 can perform a protective cover, e.g., a hood, when the second cover portion 168 is in the semi-open configuration and protect components disposed within the enclosure from rain and other environmental elements when the second cover portion 168 is in the semi-open configuration.

The second cover portion 168 can be retained in the closed configuration relative to the first cover portion 166 by a locking member, such as one or more latches 169. In an embodiment, the one or more latches 169 can include a plurality of latches disposed on opposite sides of the cover 104A. The latches 169 can share any one or more similar attributes as compared to the latches 110 described with respect to FIG. 1. In an embodiment, the latches 169 can couple the first and second cover portion 166 and 168 together. For instance, the latches 169 can be disposed on extensions 171 of the first cover portion 166.

FIG. 6 illustrates a cover 104B in accordance with another embodiment of the present disclosure. The cover 104B includes a plurality of adapters 174 extending through the cover 104B. The adapters 174 allow for optical transmission of signals through the cover 104B between an external position and an internal position defined by the enclosure 100. The adapters 174 can be angled relative to a major surface 176 of the cover 104B. For example, the adapters 174 can be angularly offset relative to the major surface 176 by at least 10°, such as at least 15°, such as at least 20°, such as at least 25°, such as at least 30°. In an embodiment, the adapters 174 can be arranged in a matrix including a plurality of columns and a plurality of rows. By way of non-limiting example, the matrix can include at least two rows, such as at least three rows, such as at least four rows and at least two columns, such as at least three columns, such as at least four columns. An outer end 178 of the adapters 174 can receive connectors associated with external optical fibers. Internal optical fibers can be coupled with the inner end (not illustrated) of the adapters 174. When coupled with the adapters 174, the external optical fibers and internal optical fibers can be in optical communication with one another to transmit optical signals into and out of the enclosure 100.

In some instances, the covers 104A and 104B can be swapped on a common housing 102 to permit reconfiguration of the enclosure 100. For example, the enclosure 100 may be originally dedicated to a first type of end use which does not require adapters 174. However, the enclosure 100 may either be repurposed in situ to require adapters 174 or be removed from a previous location and utilized at a new location where adapters 174 are required. To swap the covers 104A and 104B, the technician can remove the existing cover 104A or 104B from the hinged interface 106 and then install the new cover 104A or 104B thereon.

FIG. 7 illustrates an internal view of the enclosure 100 as seen in accordance with an exemplary embodiment. As illustrated, the enclosure 100 includes two regions-a main region 180 where initial installation steps are performed as described below, and a support region 182 where secondary connections can be completed at the time of the initial installation or at a later time.

Referring to FIGS. 4, 5 and 7, the main region 180 and support region 182 can be defined in part by the first and second cover portions 166 and 168. For example, the first cover portion 166 can close the main region 180 and the second cover portion 168 can close the support region 182. The support region 182 may be accessible when the first cover portion 166 is closed and the second cover portion 168 is semi-open, or when the cover 104A is open. The main region 180, however, may be accessible only when the cover 104A is open. In this regard, access to the main region 180 can be restricted while access to the support region 182 is permitted with the second cover portion 168 in the semi-open configuration. This may be desirable in certain instances where a first technician is required to do an initial installation of the enclosure 100, e.g., including setting up optical fibers within the enclosure 100, and a second technician is required to perform a basic operation associated, for example, with connecting a new or existing endpoint to the optical network. While the first technician may have significant experience and thus be allowed to access the main region 180 where significant skill is required, the support region 182 can be accessed by lower-level technicians with less experience without risk of damaging the components, optical fibers, or wiring scheme associated with the enclosure 100 and contained within the main region 180.

As illustrated in FIG. 7, a base tray 184 can be disposed within the housing 102. The base tray 184 can be spaced apart from the rear wall 148 (FIG. 3). In an embodiment, the base tray 184 can be coupled to the supports 156 (FIG. 3) to retain the base tray 184 at a relatively fixed position with respect to the housing 102 and elevated relative to the rear wall 148. The base tray 184 can divide an internal volume 186 of the enclosure 100 into a back region 188 and a front region 190. Inbound optical cables routed into the enclosure 100 can enter the enclosure 100 from the second side 126 of the enclosure 100 and route behind the base tray 184 through the back region 188 of the internal volume 186. These optical cables typically contain several optical fibers bundled together. The optical fibers contained in the optical cable are broken out within the back region 188 of the internal volume 186 and at least some of the optical fibers are routed around the base tray 184 to the front region 190. Other optical fibers not routed to the front region 190 may be routed back out of the enclosure 100, e.g., through the second side 126 without exiting the back region 188 of the enclosure 100, i.e., not passing around the base tray 184 to the front region 190 The enclosure 100 can house one or more optical components 192 in the front region 190. By way of non-limiting example, these optical components 192 can include splice trays, passive splitters, powered splitters, wavelength division multiplexers, other hardware, or any combination thereof. In certain instances, the optical components 192 can include different types of optical components housed within the same enclosure. In other instances, all of the optical components 192 housed in the enclosure 100 can be a same type of optical component. The optical components 192 can receive the individual optical fibers and allow a technician to perform one or more operations thereon. For example, as depicted in FIG. 7, the optical fibers can be routed into splice trays 194. The splice trays 194 can be disposed in a stacked arrangement where one or more of the splice trays 194 pivots on a pivotable mount 196 to expose one or more underlying splice trays 194. To access a lower splice tray 194, the operator can rotate any higher splice tray(s) 194 out of the way.

Portions of the optical fibers disposed within the splice trays 194 can be wrapped around one or more splice regions 195 disposed in the splice trays 194 and enter the splice regions 195. Terminal ends of the optical fibers can be spliced to intermediary optical fibers at the splice regions 195. The intermediary optical fibers extend from the splice regions 195 to a patch panel 198 where connectorized ends 200 of the intermediary optical fibers can be coupled to adapters 202 disposed in the patch panel 198. The patch panel 198 can include at least one row of adapters 202, such as two rows of adapters 202, three rows of adapters 202, or even four rows of adapters 202. The adapters 202 can each receive a connectorized end of one of the intermediary optical fibers. In this regard, each individual optical fiber entering the enclosure 100 can be associated with one of the adapters 202. The adapters 202 can span the patch panel 198 and extend from the main region 180 to the support region 182. In such a manner, the optical fibers can be accessible from the support region 182 by way of the adapters 202. Outbound optical fibers can be coupled to an appropriate adapter 202 to optically couple the outbound optical fibers to desired inbound optical fibers entering the enclosure 100 as described above. In one embodiment, at least one of the outbound optical fibers can exit the enclosure 100 through the second end 126 at a location above the base tray 184 (out of the page in FIG. 7). In another embodiment, at least one of the outbound optical fibers can be coupled with one of the adapters 174 in the cover 104B (FIG. 6) which can interface with an external connector to externally route optical signals from the enclosure 100.

As described above, a unique feature of enclosures 100 described herein is the separability of regions within the enclosure 100. Different technicians can access different regions of the enclosure based on their relative skill and in view of their assigned tasks. More skilled, initial installation technicians can have global access within the enclosure 100. Global access can include access to the main region 180 and the support region 182 in addition to the front and back regions 190 and 188. Those will global access may perform initial wiring installation, cable breakout, fiber splicing, and the like. In this regard, those with global access may require access to the entire enclosure 100 as part of their assigned tasks. Those with lesser skill may be called upon to finalize connections after the initial assembly and wiring of the enclosure 100. For example, enclosures 100 described herein may be deployed at less than full operating capacity where at least some of the adapters 202 are not in use. This may occur in high growth areas where further development is anticipated, e.g., new homes, office buildings, or the like. As development progresses, new network endpoints are necessitated. Rather than send advanced technicians to complete connection of these new network endpoints, a low-level technician can instead utilize existing adapters 202 accessed through the support region 182 to optically connect these new network endpoints. Since the adapters 202 were already coupled to the inbound optical fibers at an earlier time, this operation is significantly easier and can be performed with less skill.

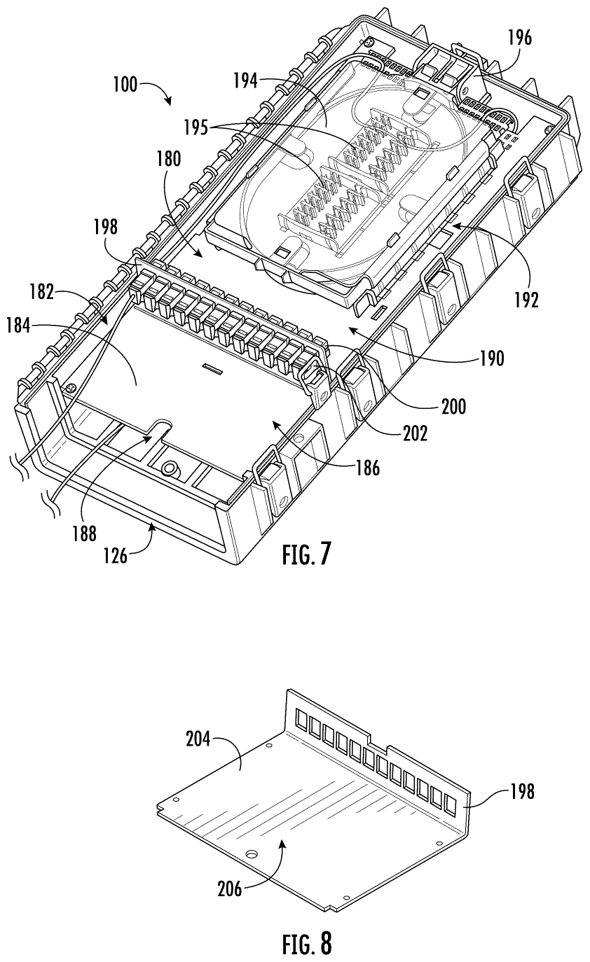

Referring to FIG. 8, an exemplary view of a drop compartment tray 204. The drop compartment tray 204 can be coupled to the base tray 184. Optical adapters (not illustrated) can be installed on the drop compartment tray 204. For example, at least six adapters can be installed on the drop compartment tray 204, such as at least twelve adapters can be installed on the drop compartment tray 204. As optical cables are installed in the enclosure 100, they can be connected with the adapters or may be spliced in. The fiber slack can be coiled in open space 206 of the drop compartment tray 204.

As previously described, enclosures require effective sealing to perform. Ingress of even small amounts of moisture can damage optical components and exposed portions of optical fiber disposed within the enclosure. Thus, lightly sealed enclosures typically cannot stand up to prolonged use. Meanwhile, heavy-duty sealing apparatuses that only seal single-size cable are similarly not effective as they disallow flexibility to work with a variety of cables as frequently encountered in the field. For example, some cables have circular outer profiles while other cables have ovular outer profiles or even polygonal outer profiles. Some cables have relatively small dimensions (e.g., less than 0.3 inches) while other cables have relatively large dimensions (e.g., greater than 0.7 inches). Use of rigid sealing structures thus precludes in-field flexibility.

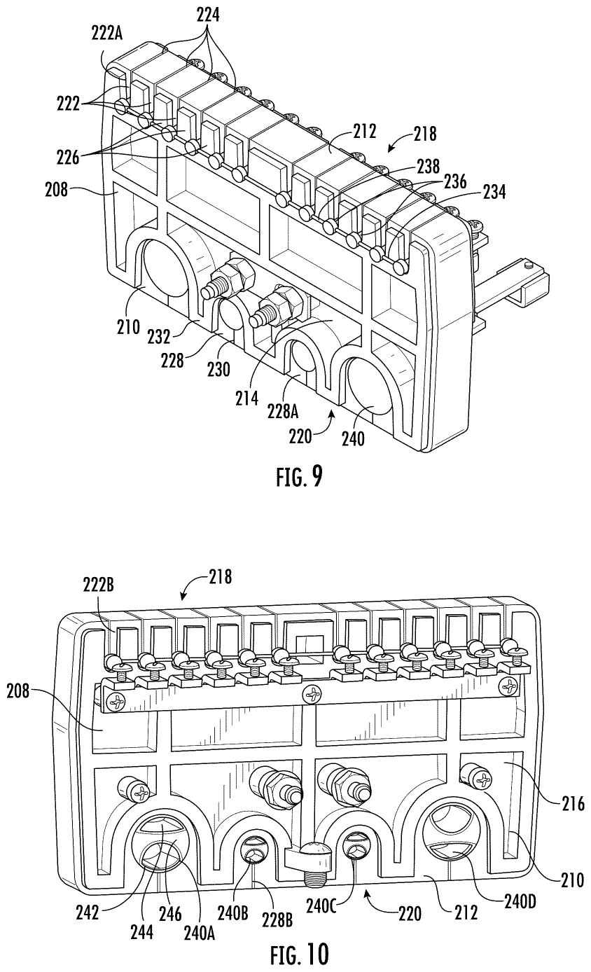

Referring to FIGS. 9 and 10, a sealing structure 208 for use with the enclosure 100 is depicted in accordance with an embodiment. The sealing structure 208 can fit within the second portion 160 of the housing 102 as described above with respect to FIG. 3. More particularly, the sealing structure 208 can be disposed between the first and second flanges 162 and 164 of the housing 102. When the cover 104A or 104B is in the closed configuration, the sealing structure 208 can seal the second end 126 of the enclosure 100 to mitigate ingress of moisture and other environmental contaminants into the enclosure 100.

The sealing structure 208 can generally include a first body 210 formed of a first material having a relatively rigid construction, and a second body 212 formed of a second material having a relatively deformable construction. By way of non-limiting example, the first body 210 can include a plastic, such as a thermoplastic, a metal, such as aluminum, an alloy, or the like. In some instances, the first body 210 can have a single piece construction. In other instances, the first body 210 can include a plurality of components coupled together to form the first body 210. By way of non-limiting example, the second body 212 can include a rubber, a gel, or the like. The second body 212 is configured to deform and deflect prior to noticeable deformation of the first body 210. As such, the first body 210 can provide a support structure against which the second body 212 can be supported to allow the second body 212 to accommodate and seal together optical fiber cables, the housing 102 and the cover 104A or 104B.

The first body 210 generally defines opposite major ends 214 and 216. The opposite major ends can form inside and outside faces, respectively, of the sealing structure 208 when the sealing structure 208 is positioned in the enclosure 100. Disposed between the opposite major ends 214 and 216 is a peripheral surface which defines a lateral aspect of the first body 210. The second body 212 can extend around the first body 210 along the peripheral surface and be deformable to accommodate any gaps extending from the external environment to the internal volume 186.

The sealing structure 208 can have different functions at different locations. For example, a first region 218 of the sealing structure 208 can be configured to receive and seal small optical fiber cables routed from the enclosure 100, e.g., to endpoint network locations, and a second region 220 of the sealing structure 208 can be configured to receive and seal relatively large optical cables routed to the enclosure 100, e.g., drop cables. The arrangement of the first and second regions 218 and 220 is merely exemplary. Yet other configurations and arrangements are possible.

The first body 210 can define a plurality of cutouts 222 associated with the first region 218 of the sealing structure 208. Each cutout 222 can be sized and shaped to receive an optical cable (not illustrated). The cutouts 222 can be sized larger than the optical cable. In the embodiment depicted in FIG. 9, the first region 218 includes twelve (12) cutouts 222. The cutouts 222 can each include a set of cutouts including a first cutout 222A defined along the major end 214 and a second cutout 222B defined along the opposite major end 216. The second body 212 can pass between the set of cutouts 222 and include a slot 224 into which the optical fiber can be translated. As depicted in FIGS. 9 and 10, each slot 224 aligns with a respective set of cutouts 222 to allow an optical fiber to pass through the sealing structure 208. Fingers 226 disposed between each cutout 222 provide support to retain the second body 212 and prevent flow and material creep of the second body 212 when the second body 212 is under compression, i.e., to seal the enclosure 100.

Similarly, the first body 210 can define a plurality of cutouts 228 associated with the second region 220 of the sealing structure 208. Each cutout 228 can be sized and shaped to receive an optical cable (not illustrated). However, unlike the cutouts 222 associated with the first region 218 which receive output optical fiber cables having relatively small cable diameters, the cutouts 228 associated with the second region 220 can receive input optical fiber cables having relatively large cable diameters. As such, the cutouts 228 are sized and shaped differently than the cutouts 222. In the embodiment depicted in FIG. 9, the second region 220 includes four (4) cutouts 228. The cutouts 228 can each include a set of cutouts including a first cutout 228A defined along the major end 214 and a second cutout 228B defined along the opposite major end 216. The second body 212 can pass between the set of cutouts 228 and include a slot 230 into which the optical fiber can be translated. As depicted in FIGS. 9 and 10, each slot 230 can align with a respective set of cutouts 228 to allow an optical fiber to pass through the sealing structure 208. Fingers 232 disposed between each cutout 228 provide support to retain the second body 212 and prevent flow and material creep of the second body 212 when the second body 212 is under compression, i.e., to seal the enclosure 100.

The second material 212 can be formed from a material that conforms to different shapes such that the slots 224 seal against fiber optic cables extending through the sealing structure 208 to mitigate ingress of contaminants. However, in some instances, one or more of the slots 224 may not actively house a fiber optic cable passing into the enclosure 100. To prevent ingress of contaminants through the unused slot(s) 224, a plug 234 can be inserted into each of the unused slots 224 to assist in sealing. The plug 234 illustrated in FIGS. 9 and 10 has a single-body (one piece) construction including a plurality of posts 236 each receivable in one of the slots 224 and a connection member 238 extending between and interconnecting the posts 236. The connection member 238 of the illustrated embodiment may be selectively frangible to permit disconnection between two or more of the posts 236. In such a manner, the plug 234 can be customized to fit the needs of the sealing structure 208. In another embodiment, the plug 234 can include a plurality of discrete bodies not connected together. Each plug 234 can be inserted into an unused slot 224 as needed.

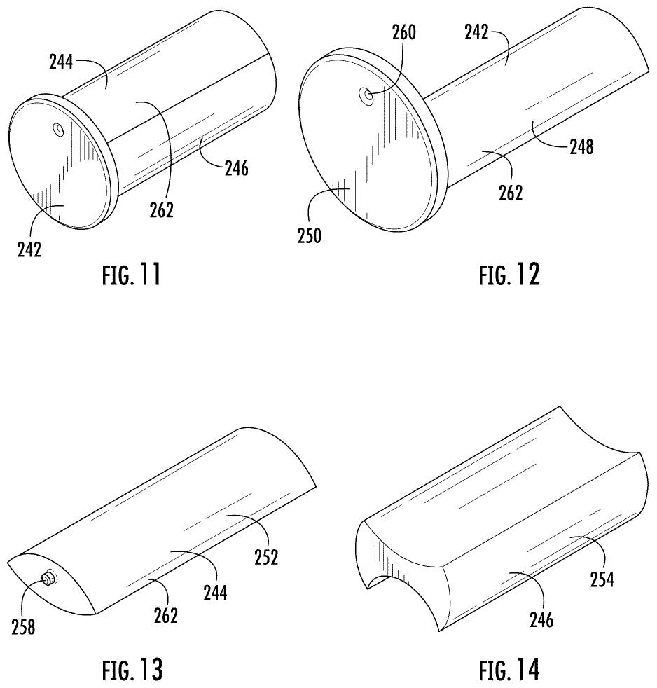

Similarly, the slots 224 can seal against fiber optic cables extending through the sealing structure 208 to mitigate ingress of contaminants. However, in some instances, one or more of the slots 224 may not actively house a fiber optic cable. To prevent ingress of contaminants through the unused slots 224, a plug 240 can be used in each of the unused slots 224 to assist in sealing. The plug 240 can be configurable between a plurality of different states. In each different state, the plug 240 can have a different configuration using various combinations of components. Each configuration can support a different type of fiber optic cable such that the plug 240 can accommodate various installations with different cable types. An exemplary embodiment of the plug 240 and its various components is illustrated in FIGS. 11 to 14.

Referring initially to FIG. 11, the plug 240 is depicted in its fully assembled state, including a first member 242, a second member 244 and a third member 246. In an embodiment, the first, second and third members 242, 244 and 246, or at least two of the first, second and third members 242, 244 and 246, can be formed from a common material. For example, the first, second and third members 242, 244 and 246 can be formed from a deformable material such as a rubber or a gel. In another embodiment, at least two of the first, second and third members 242, 244 and 246 can be formed from different materials relative to one another. For example, the first and second members 242 and 244 can be formed from a first material and the third member 246 can be formed from a second material different from the first material. In certain instances, the first material can be a relatively rigid material and the second material can be a relatively deformable material. By way of non-limiting example, the first material can include a plastic and the second material can include a deformable rubber or gel. As described below, the third member 246 can be disposed between the first and second members 242 and 244 when the plug 240 is fully assembled (i.e., all of the first, second and third members 242, 244 and 246 are present and joined together). As discussed in greater detail below, this allows the plug 240 (or less than all components of the plug 240) to be used with a plurality of different sized fiber optic cables.

The first member 242 is shown in isolation in FIG. 12. As illustrated in FIG. 12, the first member 242 includes an elongated member 248 and an end cap 250. The end cap 250 can be disposed at a terminal end of the elongated member 248. In an embodiment, the elongated member 248 and end cap 250 can be formed from a single piece. The elongated member 248 can be insertable into one of the unused slots 224. The end cap 250 forms a stop feature at the end of the elongated member 248 to prevent the first member 242 from being overinserted into the slot 230. That is, for example, the end cap 250 can have a dimension greater than the dimension of the slot 230 so that the end cap 250 presses against the second body 212 and cannot enter the slot 230. By way of non-limiting example, the elongated member 248 can have a pointed oval cross section. As illustrated in FIG. 13, the second member 244 includes an elongated member 252 that can similarly have a pointed oval cross section. As illustrated in FIG. 14, the third member 246 includes an elongated member 254 having a rounded hourglass cross section. The third member 246 can accommodate the elongated members 248 and 252 of each of the first and second members 242 and 244 in the hourglass shape. When assembled together, the first, second and third members 242, 244 and 246 can define a circular cross section. The dimension of the assembled first, second and third members 242, 244 and 246, as measured at the elongated members 248, 252 and 254, can be less than the dimension of the end cap 250. Thus, the elongated members 248, 252 and 254 can be inserted into the cutouts 230 and the end cap 250 can prevent overinsertion. In an embodiment, one or more of the first, second and third members 242, 244 and 246 can define an alignment feature 256 to assist in aligning two or more of the first, second and third members 242, 244 and 246 relative to one another. By way of example, the alignment feature 256 can include a projection 258 extending from the second member 244 and a recess 260 in the end cap 250 of the third member 248. Aligning the projection 258 and recess 260 together can cause alignment between the first, second and third members 242, 244 and 246. Alignment of the projection 258 and recess 260 can further retain the first, second and third members 242, 244 and 246 together to assist in installation of the plug 240 into the cutout 230. It should be understood that other configurations and arrangements of the plug 240 are possible. For example, in an embodiment, the end cap 250 can be part of the second or third member 244 or 246 or a combination of any two or more of the first, second and third members 242, 244 and 246.

Referring again to FIG. 10, plugs 240A, 240B, 240C and 240D are illustrated in the slots 224. Referring to plug 240A, the first and second members 242 and 244 are depicted as hollow. That is, a sidewall 262 (FIGS. 11 to 13) of the first and second members 242 and 244 is not supported by internal fill. Moreover, the internal ends of the first and second members 242 and 244 are open, thus revealing a hollow cavity within the sidewall 262. In an embodiment, the third member 246 can also define a hollow construction or an open end. Moreover, any one of the first, second and third members 242, 244 and 246 can alternatively be constructed to have a hollow or non-hollow construction. Hollow construction reduces the mass of plugs 240 and simultaneously creates compliance with the second body 212 (i.e., the plugs 240 may more readily deform to fit within the cutouts 230). Any one or more of the other plugs 240B, 240C and 240D can similarly contain a hollow or semi-hollow construction as desired. Moreover, each of the plugs 240A, 240B, 240C and 240D can share any one or more common attributes or have any one or more different attributes as compared to one another. For example, the fully assembled plugs 240B and 240C (including all of the first, second and third members 242, 244 and 246) are depicted with a first diameter while the fully assembled plugs 240A and 240D (including all of the first, second and third members 242, 244 and 246) are depicted with a second diameter different than the first diameter. One non-limiting example where such different sized cutouts 230 and plugs 240 may be applicable is when a drop cable is routed into the enclosure 100 through the cutout 230 associated with the first plug 240A and only some of the optical fibers contained in that drop cable are spliced within the enclosure 100. The non-spliced optical fibers may be routed out of the enclosure 100 through a second one of the cutouts 230 associated with the second plug 240B. As some of the optical fibers are removed from the exiting fiber optic cable passing through the cutout 230 associated with the second plug 240B, the fiber optic cable routed therethrough has a smaller diameter, thus requiring a smaller cutout size.

Alternatively, or in addition to different sized cutouts 230, it is possible to achieve different size accommodations within the cutouts 230 using the plugs 240 in combination with the fiber optic cables.

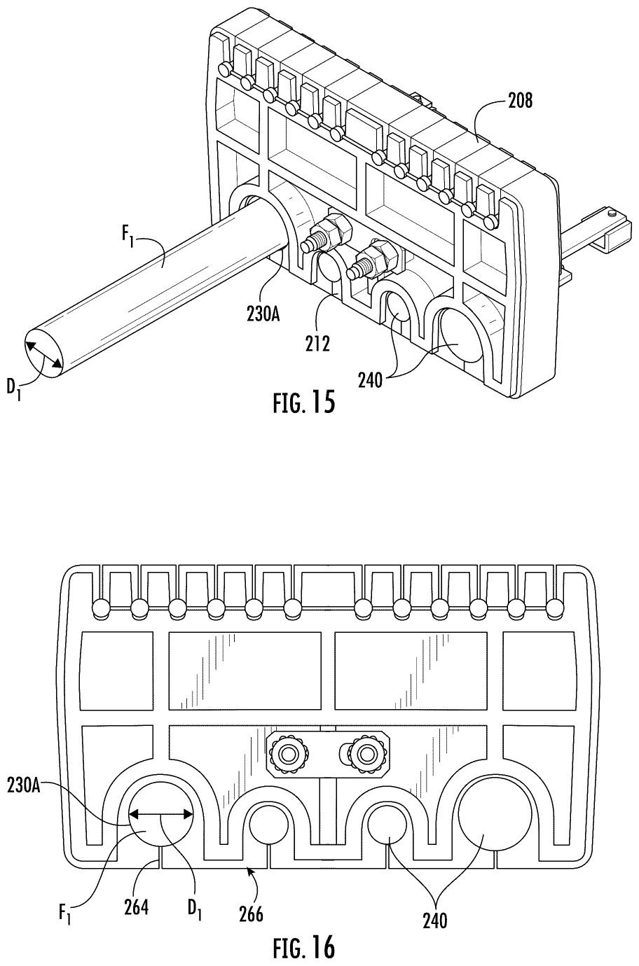

Referring initially to FIGS. 15 and 16, the sealing structure 208 is shown with a first fiber optic cable F₁ extending through a first one of the slots 230A. The first fiber optic cable F₁ has a first diameter D₁, as measured at the first slot 230A. D₁ is shown taking up the entire diameter of the first slot 230A. Thus, there is no plug 240 utilized with the first slot 230A. Instead, the second body 212 of the sealing structure 208 contacts and seals against the entire, or substantially entire, circumferential surface of the first fiber optic cable F₁ at the first slot 230A. As used with respect to contact and sealing between the second body 212 and the first fiber optic cable F₁, “substantially entire” is intended to refer to sealing contact along at least 90% of the circumference of the first fiber optic cable F₁, such as at least 95% of the circumference of the first fiber optic cable F₁, such as at least 98% of the circumference of the first fiber optic cable F₁, such as at least 99% of the circumference of the first fiber optic cable F₁, such as at least 99.9% of the circumference of the first fiber optic cable F₁. Any non-sealed circumferential portion of the first fiber optic cable F₁ is ideally minimal and may occur as a result of a slit 264 extending from an outer peripheral surface 266 of the second body 212 to the first slot 230A itself which allows for lateral insertion of the fiber optic cable into the first slot 230A. At the location where the slit 264 meets the first slot 230A it may be possible for tiny gapping to occur. However, material selection, sizing and shaping of the first slot 230A and slit 264 can all be selected to eliminate any gap along the circumferential surface of the first fiber optic cable F₁ at locations adjacent to the slit 264. For example, when the second body 212 is formed from a readily flowable material, such as a gel, any gap formed between the first fiber optic cable F₁ and the second body 212 at the location of the gap will self-close when the sealing structure 208 is acted upon, e.g., squeezed, by the housing 102 and cover 104A or 104B.

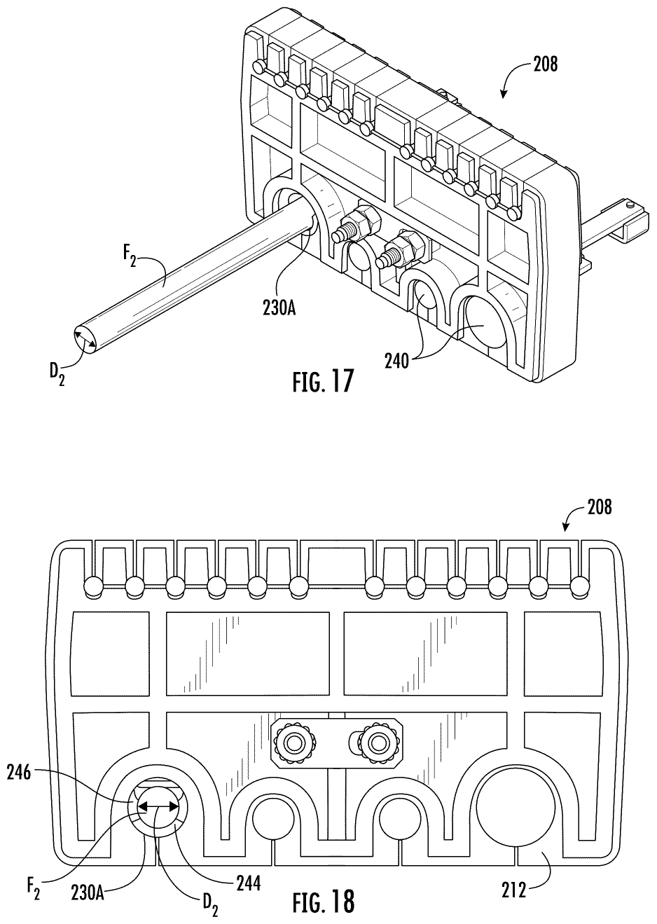

FIGS. 17 and 18 show the sealing structure 208 with a second fiber optic cable F₂ extending through the first one of the slots 230A. The second fiber optic cable F₂ has a second diameter D₂, as measured at the first slot 230A. Unlike the first diameter D₁ of the first fiber optic cable F₁, the second diameter D₂ of the second fiber optic cable F₂ does not take up the entire diameter of the first slot 230A. That is, D₂ is less than the diameter of the first slot 230A. By way of non-limiting example, the first diameter D₁ may be approximately 21 millimeters (mm) while the second diameter D₂ may be approximately 12.5 mm. To accommodate the second fiber optic cable F₂, the plug 240, and more particularly portions of the plug 240, can be used within the first slot 230A to help seal the first slot 230A closed around the second fiber optic cable F₂.

As shown in FIG. 18, the plug 240 is installed in the first slot 230A with the second and third members 244 and 246 present and the first member 242 removed. The third member 246 can include a deformable material configured to flow (i.e., move) to conform to the size and shape of the second fiber optic cable F₂. By way of non-limiting example, the third material 246 can include a rubber or gel. The third member 246 and second body 212 can combine to contact and seal against the entire, or substantially entire, circumferential surface of the second fiber optic cable F₂ at the first slot 230A. A ratio of circumferential contact between the second fiber optic cable F₂ and third member 246 and the second fiber optic cable F₂ and the second body 212 can be in a range between and including 1:10 and 10:1, such as in a range between and including 1:5 and 5:1, such as in a range between and including 1:2 and 2:1. The second member 244 may be spaced apart from the second fiber optic cable F₂ and take up space within the first slot 230A. In a particular embodiment, the third member 246 can be disposed between the second member 244 and the second fiber optic cable F₂.

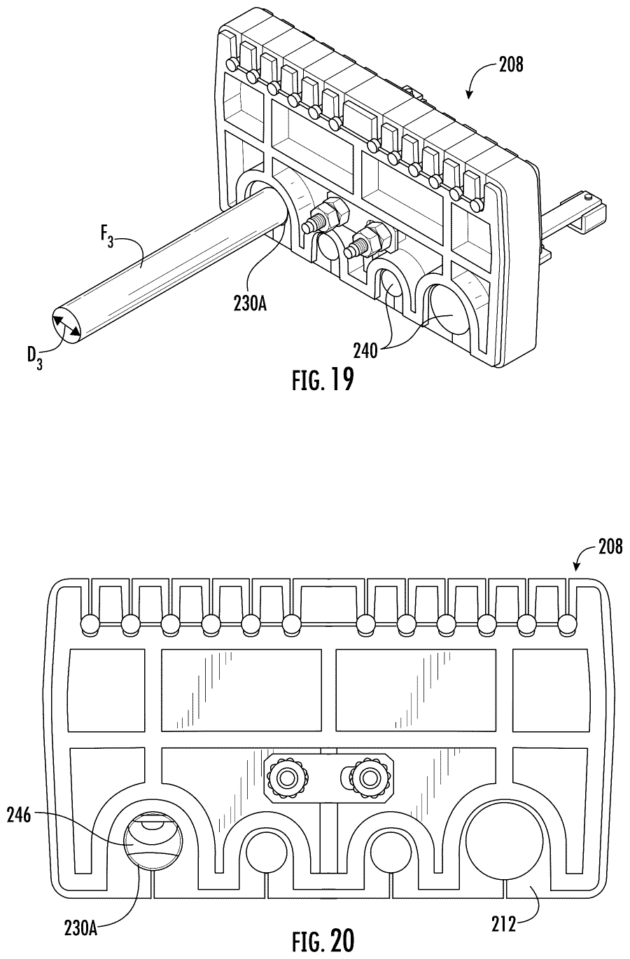

FIGS. 19 and 20 show the sealing structure 208 with a third fiber optic cable F₃ extending through a first one of the slots 230A. The third fiber optic cable F₃ has a third diameter D₃, as measured at the first slot 230A. Similar to the diameter D₂ of the second fiber optic cable F₂, the third diameter D₃ of the third fiber optic cable F₃ does not take up the entire diameter of the first slot 230A. However, the third diameter D₃ is less than the first diameter D₁ and greater than the second diameter D₂. By way of non-limiting example, the third diameter D₃ can be approximately 16 mm. To accommodate the third fiber optic cable F₃, the plug 240, and more particularly portions of the plug 240, can be used within the first slot 230A to help seal the first slot 230A closed around the third fiber optic cable F₃.

As shown in FIG. 20, the plug 240 is installed in the first slot 230A with the third member 246 present and the first and second members 242 and 244 removed. The third member 246 can include a deformable material configured to flow (i.e., move) to conform to the size and shape of the third fiber optic cable F₃. By way of non-limiting example, the third material 246 can include a rubber or gel. The third member 246 and second body 212 can combine to contact and seal against the entire, or substantially entire, circumferential surface of the second fiber optic cable F₂ at the first slot 230A. A ratio of circumferential contact between the third fiber optic cable F₃ and third member 246 and the third fiber optic cable F₃ and the second body 212 can be in a range between and including 1:10 and 10:1, such as in a range between and including 1:5 and 5:1, such as in a range between and including 1:2 and 2:1.

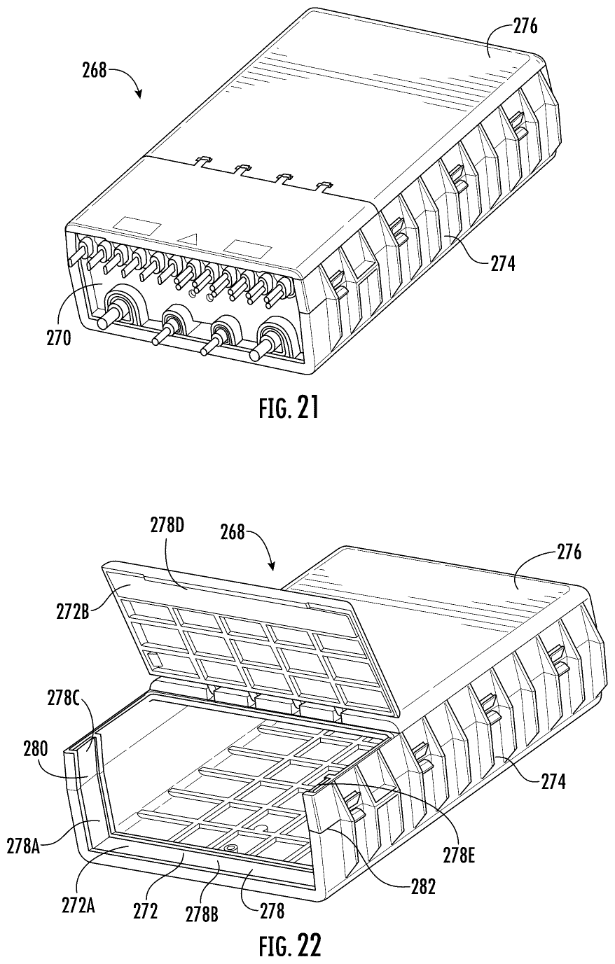

FIGS. 21 and 22 illustrate an enclosure 268 in accordance with another embodiment. FIG. 21 illustrates a view of the enclosure 268 in a fully closed, i.e., sealed, configuration whereby components and fiber splices disposed within the enclosure 268 are protected from environmental factors. FIG. 22 illustrates the enclosure 268 in a semi-open configuration with a sealing structure 270 of the enclosure 268 (FIG. 21) removed from an area 272 defined by a housing 274 and cover 276 of the enclosure 268. The area 272 can have any one or more similar features as compared to the first portion 160 (FIG. 3) defined between the first and second flanges 162 and 164. As depicted in FIG. 22, the area 272 is defined by a portion 272A of the housing 274 and a portion 272B of the cover 276.

A material 278 can be disposed within either or both of portions 272A or 272B. Referring initially to portion 272A, the material 278 can provide a seal interface between the housing 274 and the sealing structure 270. The material 278 can also, or alternatively, provide a retention function by retaining the sealing structure 270 within the area 272. For example, the material 278 can include an adhesive or a sticky material. In an embodiment, the material 278 can extend continuously from a first end 280 to a second end 282 of the portion 272A. In another embodiment, the material 278 can include a plurality of segments, such as for example, a first segment 278A, a second segment 278B and a third segment (disposed on an opposite side compared to the first segment 278A). The material 278 can further be divided into any number of other segments, such as two segments, four segments, five segments, six segments, etc.

The portion 272B of the area 272 on the cover 276 can also include the material 278. The material 278 can be divided between a plurality of segments, such as a fourth segment 278C, a fifth segment 278D and a sixth segment 278E. The fourth and sixth segments 278C and 278E can be disposed on opposite lateral sides of the cover 276 while the fifth segment 278D can be disposed on a major face of the cover 276.

Combined together, the segments 278A, 278B, 278C, 278D, 278E, etc. of material 278 can form a sealing interface between the sealing structure 270 and each of the housing 274 and cover 276. In some instances, the material 278 can flow under pressure to close any voids or gaps between the sealing structure 270 and each of the housing 274 and cover 276. For example, the material 278 can include a gel or rubber which deflects under load. When the cover 276 is in the closed configuration, pressure exerted on the material 278 between the sealing structure 270 and each of the housing 274 and cover 276 can cause the material 278 to deform and flow to fill any voids or gaps.

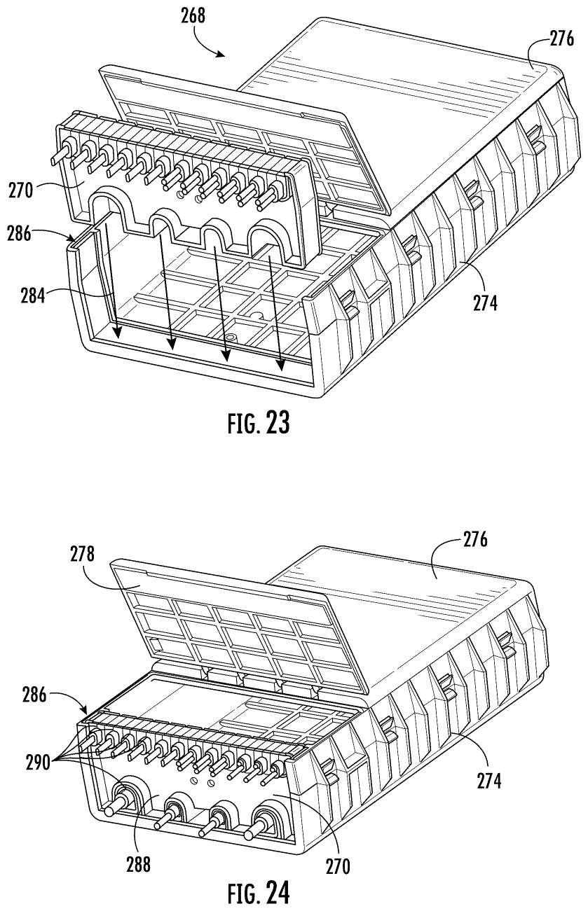

FIG. 23 illustrates a view of the sealing structure 270 as it is being introduced to the housing 274 via translation in a direction as shown by arrows 284. Initially, prior to installation of the sealing structure 270, the cover 276 is moved to the open or semi-open configuration as described above. In this configuration, the area 272 is open from a front side 286 of the enclosure 268 to permit entrance of the sealing structure 270 into the enclosure 268. The sealing structure 270 is then translated into the area 272 as shown in FIG. 24. In the position shown in FIG. 24, the sealing structure 270 may not be fully seated within the area 272. That is, the sealing structure 270 may not be at its final seated position relative to the area 272 and a portion of the sealing structure 270 may be disposed above the front side 286 of the enclosure 268. For example, the material 278 on the housing 274 (FIG. 23) may not be fully compressed by the sealing structure 270. To seat the sealing structure 270, the cover 276 can be closed. As the cover 276 is moved to the closed position, an inside surface of the cover 276 (or the material 278 disposed on the cover 276) can impart a force to the sealing structure 270 to cause the sealing structure 270 to compress into the material 278 disposed on the housing 274. In this regard, the cover 276 can form a tight seal with the sealing structure 270.

The sealing structure 270 can include any one or more similar attributes as compared to the sealing structure 208. For example, the sealing structure 270 can include a first body 288 formed from a relatively rigid material. The first body 288 can form a support platform of the sealing structure 270. The first body 288 of the sealing structure 270 can support a plurality of second bodies 290 each configured to form a sealing interface with one or more fiber optic cables. Each one of the second bodies 290 can be removably coupled to the first body 288. The first body 288 can be configured to receive at least two (2) second bodies 290, such as at least five (5) second bodies 290, such as at least ten (10) second bodies 290, such as at least twenty (20) second bodies 290, such as at least thirty (30) second bodies 290, such as at least fifty (50) second bodies 290.

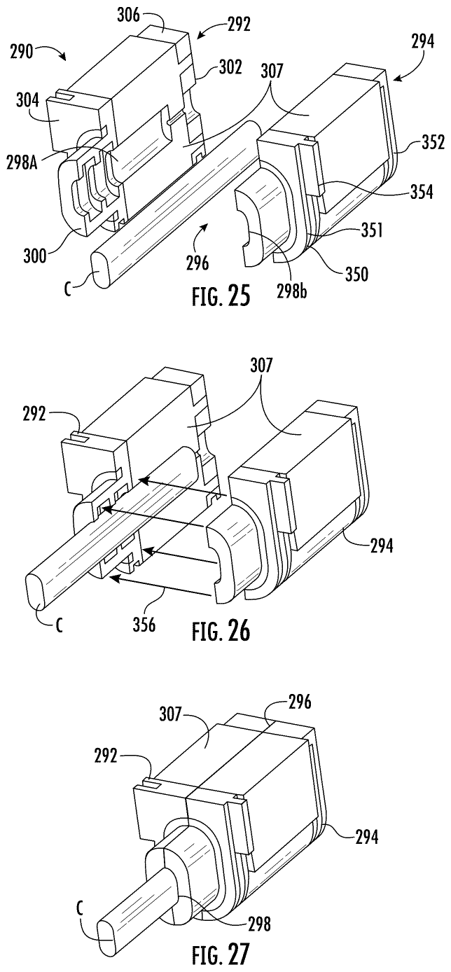

FIGS. 25 to 27 illustrate a view of one of the second bodies 290 in accordance with an exemplary embodiment. In particular, FIG. 25 illustrates a view of the second body 290 prior to assembly, FIG. 26 illustrates a view of the second body 290 during assembly, and FIG. 27 illustrates a view of the second body 290 after an initial assembly.

Referring initially to FIG. 25, the second bodies 290 can have a multi-piece construction. The multi-piece construction can include, for example, two halves comprising a first half 292 and a second half 294. The first and second halves 292 and 294 can be interfaced with one another at a seam 296. In an embodiment, the seam 296 lies along a plane such that the entire first half 292 (or substantially all of the first half 292) is disposed on a first side of the plane and the entire second half 294 (or substantially all of the second half 294) is disposed on a second side of the plane opposite the first side. In some instances, the seam 296 can be connected. i.e., the first and second halves 292 and 294 can be coupled together through a seamed interface. In other instances, the seam 296 can be detached such that the first and second halves 292 and 294 are not coupled together.

Each of the first and second halves 292 and 294 can define a portion of a cable receiving cutout 298A and 298B, respectively, such that when the first and second halves 292 and 294 are interfaced with one another, i.e., brought together, an entire cable receiving cutout 298 is defined. The cable receiving cutout 298 can extend between a first end 300 and a second end 302 of the second body 290. The first end 300 can correspond with an external side of the enclosure 268 and the second end 302 can correspond with an internal side of the enclosure 268.

In an embodiment, at least one of the first and second halves 292 and 294 can have a multi-piece construction. For example, the first half 292 can include a first end plate 304 and a second end plate 306 spaced apart from one another by a sealing member 307. In an embodiment, the first and second end plates 304 and 306 can float relative to one another with the sealing member 307 coupling the first and second end plates 304 and 306 together. As used with respect to the first and second end plates 304 and 306, the term “float” is intended to refer to a relatively moveable engagement whereby the first and second end plates 304 and 306 are coupled together but moveable with respect to one another. The first half 292 can thus be compliant to interface with the first body 288 (FIG. 24) as described below while also providing support to the sealing member 307.

FIGS. 28 and 29 illustrate views of the first end plate 304 in accordance with an exemplary embodiment. Specifically, FIG. 28 illustrates the first end plate 304 as seen from a position external to the enclosure 268 and FIG. 29 illustrates the first end plate 304 as seen from a position within the enclosure 268. As depicted, the first end plate 304 defines a wall 308 and a projection 310 extending from the wall 308. The wall 308 defines a first side 312 and a second side 314. The sealing member 307 can abut the first side 312 of the wall 308. One or more openings 316 can extend through the wall 308 between the first and second sides 312 and 314. The openings can be in communication with one another through a channel 318. In an embodiment, the channel 318 can extend around the projection 310 and be recessed from the second side 314. In such a manner, the sealing member 307 can be overmolded to the first end plate 304 such that a portion of the sealing member 307 extends through the one or more openings 316 and at least partially fills, such as entirely fills, the channel 318. As the portion of the sealing member 307 disposed in the channel 318 is larger than the opening(s) 316, the sealing member 307 can be prevented from pulling away from the first end plate 304. The sealing member 307 can thus be retained at the first end plate 304 by the portion of the sealing member 307 disposed within the channel 318. In certain instances, the sealing member 307 can also be coupled directly to the first side 312 of the wall 308, e.g., as a result of an overmolding process.

The projection 310 can extend from the second side 314 of the wall 308. The projection 310 can define a generally arcuate outer surface 320 and a recess 322 which extend from the second side 314 of the wall 308. The recess 322 can correspond with the aforementioned cable receiving cutout 298 (FIG. 25). In an embodiment, the recess 322 is oversized relative to the dimension of a fiber optic cable to be received therein. The recess 322 can include ribs 324 with cable engagement surfaces 326 to interface with the fiber optic cable received in the recess 322. In certain instances, the cable engagement surfaces 326 can be shaped or sized to form an interference fit with the fiber optic cable. In some embodiments, the cable engagement surfaces 326 can include teeth, castellations, surface texture, knurling, or other cable gripping features to increase grip on the fiber optic cable.

In an embodiment, the wall 308 can further include a linking feature 328 configured to interact with an adjacent one of the second bodies 290 (FIG. 25) or the first body 288 (FIG. 25). The linking feature 328 can act to retain the second body 290 at a fixed position relative to an adjacent second body 290 or the first body 288. In an embodiment, the linking feature 328 can be a groove 330 extending inward from a peripheral outer surface 332 of the wall 308. As depicted in FIGS. 28 and 29, the wall 308 can have a shape such that the depth of the groove 330 is different at different locations along a length of the groove 330. For example, the groove 330 can define a first depth D₁ at a first location 334 and a second depth D₂ at a second location 336 spaced apart from the first location 334. In an embodiment, the first location 334 can correspond with a tab 338 of the wall 308. The tab 338 can extend from the wall 308 in a direction generally parallel with the first and second sides 312 and 314.

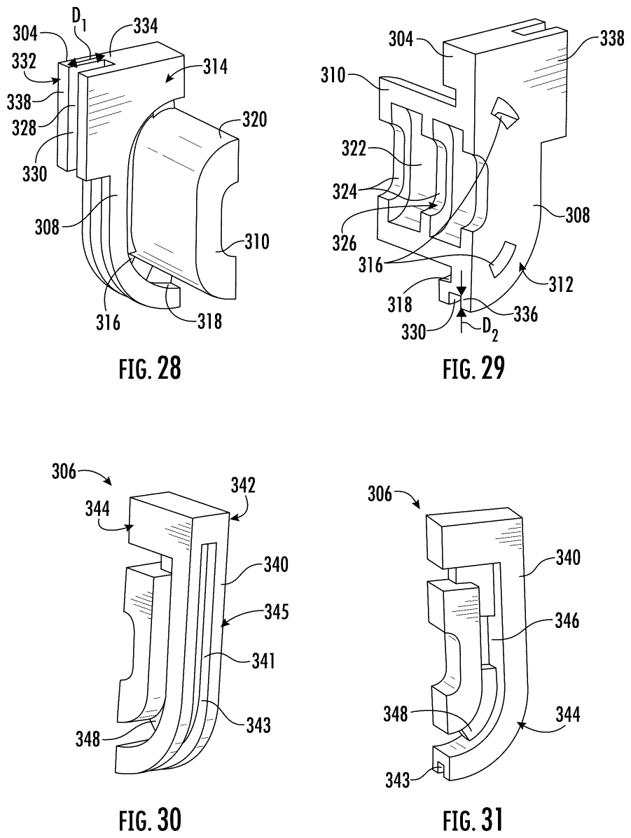

FIGS. 30 and 31 illustrate views of the second end plate 306 in accordance with an exemplary embodiment. As illustrated, the second end plate 306 can include a wall 340 defining a first side 342 and a second side 344. The sealing member 307 can abut the first side 342 of the wall 340. One or more openings 346 can extend through the wall 340 between the first and second sides 342 and 344. The openings 346 can be in communication with one another through a channel 348. In such a manner, the sealing member 307 can be overmolded to the second end plate 306 such that a portion of the sealing member 307 extends through the one or more openings 346 and at least partially fills, such as entirely fills, the channel 348. As the portion of the sealing member 307 disposed in the channel 348 is larger than the opening(s) 346, the sealing member 307 can be prevented from pulling away from the second end plate 306. The sealing member 307 can thus be retained at the second end plate 306 by the portion of the sealing member 307 disposed within the channel 348. In certain instances, the sealing member 307 can also be coupled directly to the first side 342 of the wall 340, e.g., as a result of an overmolding process.

In an embodiment, the wall 340 can further include a linking feature 341 configured to interact with an adjacent one of the second bodies 290 (FIG. 25) or the first body 288 (FIG. 25). The linking feature 341 can act to retain the second body 290 at a fixed position relative to the adjacent second body 290 or the first body 288. In an embodiment, the linking feature 341 is a groove 343 extending inward from an outer surface 345 of the wall 340.

In an embodiment, the first end plate 304 illustrated in FIGS. 28 and 29 and the second end plate 306 illustrated in FIGS. 30 and 31 can be mirrored or substantially mirrored to form third and fourth end plates 350 and 352 of the second half 294 of the second body 290 (FIG. 25). However, in some instances the third and fourth end plates 350 and 352 can have differences as compared to the first and second end plates 304 and 306. For example, as depicted in FIG. 25 and in accordance with an embodiment, a wall 351 of the third end plate 350 can define a tongue 354 which is receivable in a portion of the groove 330 in the wall 308 of a neighboring second body 290.

Referring again to FIG. 25, a fiber optic cable C can be inserted in the seam 296 between the first and second halves 292 and 294 and introduced into one of the cable receiving cutouts 298A or 298B as shown in FIG. 26. The first and second halves 292 and 294 can then be brought together as indicated by arrows 356 until the first and second halves 292 and 294 are interfaced together at the seam 296 as illustrated in FIG. 27. With the first and second halves 292 and 294 interfaced and assembled together, the sealing member 307 can form a continuous, or substantially continuous, seal around a perimeter of the fiber optic cable C. In some instances, the fiber optic cable C and the sealing member 307 can have voids or gaps therebetween when the first and second halves 292 and 294 are brought together. These voids or gaps can be mitigated or eliminated as described below.

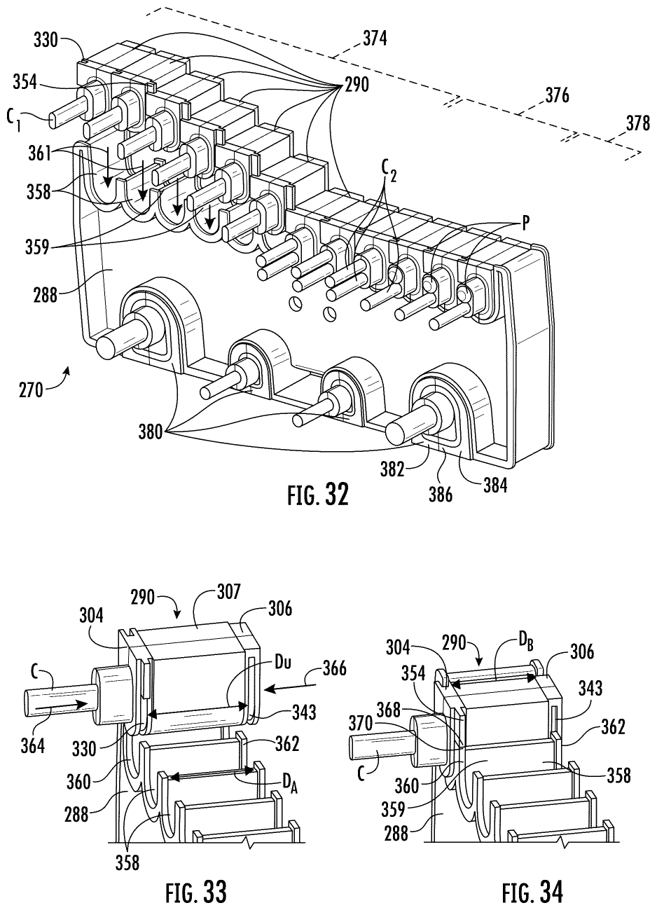

As shown in FIG. 32, the assembled second bodies 290 can each be coupled to the first body 288. For example, each of the assembled second bodies 290 can be installed within a receiving area 358 of the first body 288. In an embodiment, the receiving areas 358 can be shaped to accommodate the second bodies 290. For example, each of the receiving areas 358 can have an arcuate shape which matches an arcuate shape of the second bodies 290. In an embodiment, the receiving areas 358 can be separated from one another by a sidewall 359. The sidewall 359 can be a continuation of the arcuate shape of the receiving area 358. That is, the sidewall 359 can define a smooth guiding surface to guide the second bodies 290 into the receiving areas 358 in a direction shown by arrows 361. In some instances, the sidewall 359 can be disposed between at least a portion of adjacent second bodies 290 and 290.

In an embodiment, the aforementioned tongue and grooves 354 and 330 can interface with one another at a location above the sidewall 359 (the term “above” is intended to refer to the orientation as depicted in FIG. 32). As the second bodies 290 are translated into the receiving areas 358, the tongue and grooves 354 and 330 of adjacent second bodies 290 can interface with one another to seat the second bodies 290 relative to each other and the first body 288.

FIGS. 33 and 34 depict an exemplary embodiment of the first and second bodies 288 and 290 where the grooves 330 of the first end plate 304 of the second body 290 interface with an engagement surface, e.g., a first flange 360, of the first body 288 and the grooves 343 of the second end plate 306 of the second body 290 interface with an engagement surface, e.g., a second flange 362 of the first body 288. The first and second flanges 360 and 362 can be spaced apart from one another by a dimension D_{A}. In an unbiased state, i.e., without imparting loading forces to the second body 290, the grooves 330 and 343 of the second body 290 can be spaced apart by an unbiased dimension Du that is greater than the dimension D_{A}. For example, Dᵤ can be at least 1.01 D_{A}, such as at least 1.02 D_{A}, such as at least 1.03 D_{A}, such as at least 1.04 D_{A}, such as at least 1.05 D_{A}, such as at least 1.1 D_{A}, such as at least 1.2 D_{A}, such as at least 1.3 D_{A}, such as at least 1.4 D_{A}.

In an embodiment, at least some of the second bodies 290 can be compressed by the first body 288 when installed relative therewith. In a more particular embodiment, all of the second bodies 290 can be compressed by the first body 288. For example, the first and second end plates 304 and 306 of the second bodies 290 can be compressed, i.e., translated together, in the directions shown by arrows 364 and 366. More particularly, force can be applied to the first end plate 304 in the direction shown by arrow 364 and force can be applied to the second end plate 306 in the direction shown by arrow 366. The force shown by arrows 364 and 366 can be applied to the first and second end plates 304 and 306 prior to or during installation of the second bodies 290 relative to the first body 288. The force can be sufficient to compress the second bodies 290 such that the grooves 330 and 343 align with the first and second flanges 360 and 362, respectively. In this regard, the first and second grooves 330 and 343 are spaced apart by a biased dimension D_{B}, that is approximately equal to D_{A}.

Compression of the second bodies 290 can occur primarily at the sealing member 307. The sealing member 307 can generally include a deformable body configured to deflect during loading to accommodate gaps and voids which might otherwise permit entrance of environmental debris into the enclosure 268. By way of non-limiting example, the sealing member 307 can include a rubber, such as neoprene rubber, silicone rubber, nitrile rubber, EPDM rubber, styrene-butadiene rubber, butyl rubber, or fluorosilicone rubber. By way of another example, the sealing member 307 can include a gel, such as a chromium (III)-carobxylate/acrylamide-polymer gel, a chromium (VI) redox gel, an aluminum crosslinked gel, a gel crosslinked with an organic crosslinker, a biopolymer gel, a monomer gel, a polymer self-induced gel, an inorganic gel, or a gel formulated with synthetic organic polymers. Yet other rubbers, gels and sealing materials can be used with the sealing member 307. In an embodiment, the sealing member 307 comprises a homogenous construction. In this regard, the sealing member 307 can exhibit readily modeled deflection characteristics and loading attributes to ensure effective sealing of the enclosure 268. In another embodiment, the sealing member 307 can have a heterogenous construction, including, e.g., a plurality of layers or sections each having a different chemical composition or a variable composition whereby a same material is altered at one or more locations of the sealing member 307 to have a different property as compared to another location of the sealing member 307.

By compressing the first and second end plates 304 and 306 together and installing the second bodies 290 into the receiving areas 358 in the compressed state, the sealing member 307 can operate under load, resulting in the material of the sealing member 307 flowing within the receiving areas 358 and relative to a cable C to form a sealed interface thereagainst and prevent ingress of contaminants into the enclosure 268. The first and second flanges 360 and 362 can retain the grooves 330 and 343 to maintain the second body 290 in the compressed state.

As shown in FIG. 34, a lower surface 368 of the tongue 354 can be disposed adjacent to an upper surface 370 of the first flange 360 at an upper end of the sidewall 359. In an embodiment, the lower and upper surfaces 368 and 370 can act as stop features to prevent overinsertion of the second body 290 into the receiving area 358. In another embodiment, the lower and upper surfaces 368 and 370 can seal relative to one another to prevent ingress of fluid therethrough.

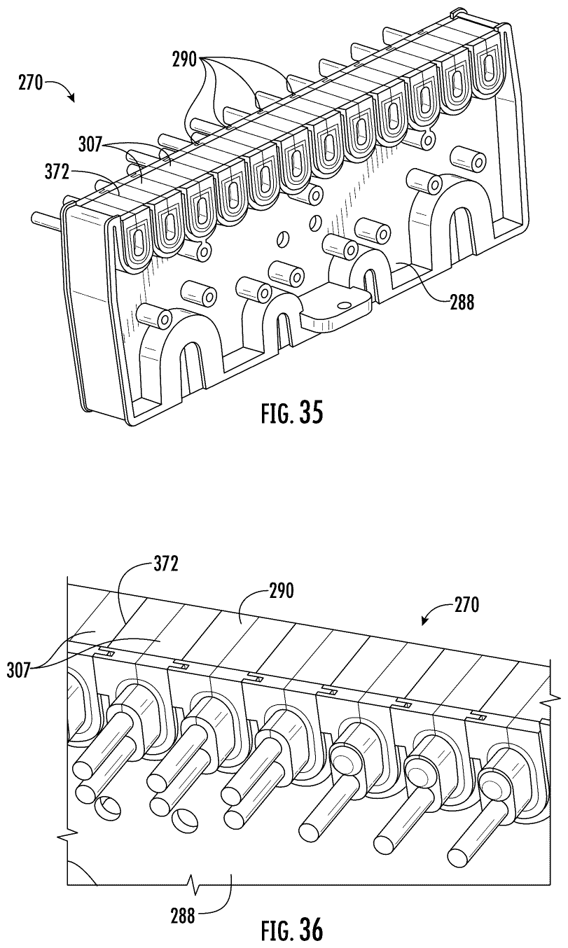

FIGS. 35 and 36 illustrate the sealing structure 270 as seen with the second bodies 290 all installed relative to the first body 288. As depicted, the sealing members 307 of adjacent second bodies 290 can contact one another at joints 372.

Fluidic sealing at joints 372 can occur by compressive forces generated by the sealing members 307 of neighboring second bodies 290 compressing against one another during compression of the first and second endplates 304 and 306 as shown in FIGS. 33 and 34.

It is noted that the second bodies 290 can be used with different types of cables. For example, FIG. 32 illustrates a first group 374 of second bodies 290 receiving an oval shaped cable C₁, a second group 376 of second bodies 290 receiving two round shaped cables C₂, and a third group 378 of second bodies 290 receiving one round shaped cable C₂ and a plug P. The different groups 374, 376 and 378 of second bodies 290 can be used in any one or more combinations based on the requirements of the enclosure 268. Moreover, while the groups 374, 376 and 378 of second bodies 290 are shown in continuous blocks of common types (i.e., all of the first group 374 of second bodies 290 are adjacent one another, all of the second group 376 of second bodies 290 are adjacent one another, and all of the third group 378 of second bodies 290 are adjacent one another), it should be understood that the different types of second bodies 290 can be alternatively arranged based on the requirements of the enclosure 268. Yet further, other types of cables and plugs can be used with the second bodies 290 as required based on the wiring of the enclosure 268 and the inbound and outbound cables at the site of the enclosure 268.

The first, second and third groups 374, 376 and 378 of second bodies 290 described above may be used with outbound fiber optic cables. The outbound fiber optic cables can have relatively small cross-sectional areas as a result of a low number of optical fibers disposed therein. Referring still to FIG. 32, the sealing structure 270 can further include second bodies 380 configured to receive inbound fiber optic cables with relatively large cross-sectional areas as a result of a high number of optical fibers disposed therein. The second bodies 380 can have any one or more common features or attributes as described above with respect to the second bodies 290. For example, the second bodies 380 can have a multi-piece construction. The multi-piece construction can include, for example, two halves comprising a first half 382 and a second half 384. The first and second halves 382 and 384 can be interfaced with one another at a seam 386. In an embodiment, the seam 386 lies along a plane such that the entire first half 382 (or substantially all of the first half 382) is disposed on a first side of the plane and the entire second half 384 (or substantially all of the second half 384) is disposed on a second side of the plane opposite the first side. The first and second halves 382 and 384 can include any one or more common features or attributes as described above with respect to the first and second halves 292 and 294 of the second bodies 290. For example, the first half 382 can include rigid end plates and a sealing member disposed therebetween. In certain instances, the second bodies 380 can have one or more different features or attributes as described above with respect to the second bodies 290. For example, whereas the second bodies 290 can disposed adjacent to one another in sealing contact with each another, the second bodies 380 may be spaced apart from one another. That is, the second bodies 380 may not contact one another. As a result, lateral aspects of the second bodies 380 may be different to interface with the first body 288 or removed altogether.

FIGS. 37 to 47 illustrate a sealing structure 388 and components associated therewith in accordance with another embodiment. The sealing structure 388 may be used with an enclosure similar to the enclosure 100 or 268 described above. Similar to the sealing structures 208 and 270, the sealing structure 388 can include a first body 390 forming a support structure for a plurality of sealing interfaces, such as a first sealing interface 392, a second sealing interface 394, a third sealing interface 396 and a fourth sealing interface 398. Each sealing interface 392, 394, 396 and 398 can support a cable extending through the sealing structure 388. The different sealing interfaces 392, 394, 396 and 398 can support same, similar, or differently sized cables. For example, as depicted in FIG. 37, the first sealing interface 392 can support a first cable C₁ having a first diameter and the second sealing interface 394 can support a second cable C₂ having a second diameter different than the first diameter.

Each sealing interface 392, 394, 396 and 398 can define a cutout 400 extending into the first body 390. The cutout 400 depicted in FIG. 37 and the following description is made with respect to the first sealing interface 392, however it should be understood that the principles described with respect to the first sealing interface 392 may also, or alternatively, apply to any one or more of the other sealing interfaces.

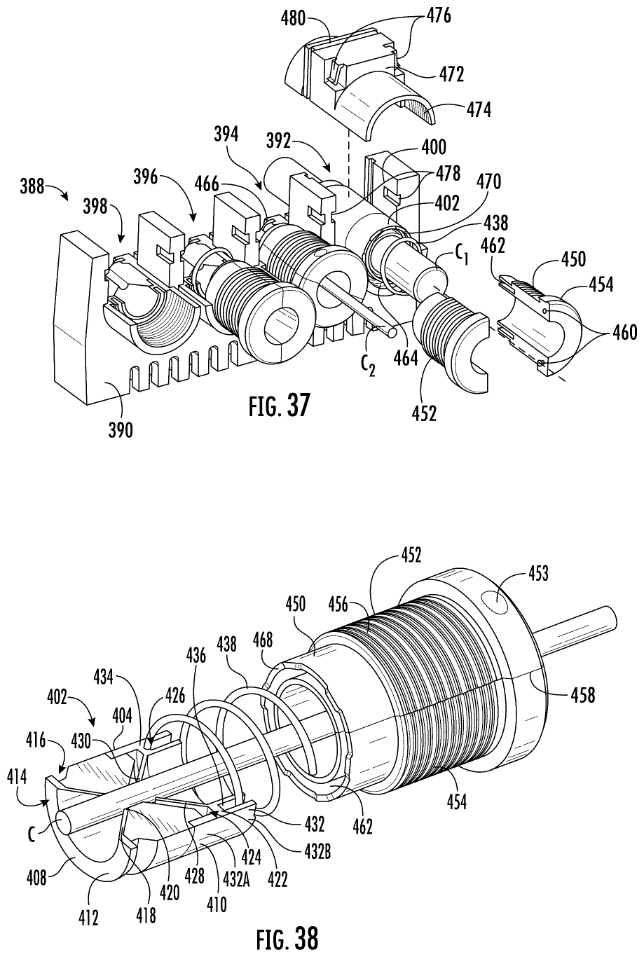

The cutout 400 can be sized and shaped to receive a second body 402. The second body 402 can seal relative to the cable extending through the sealing interface 392 and the sidewall of the cutout 400. A portion of the second body 402 is illustrated in FIG. 38. More particularly, FIG. 38 illustrates a first half 404 of the second body 402. The depicted first half 404 can be assembled with a complementary second half 406 (FIGS. 40 to 42) to form the second body 402. In an embodiment, the first and second halves 404 and 406 can share one or more common features or attributes as compared to one another. In a more particular embodiment, the first and second halves 404 and 406 can be the same, or substantially same, structure rotated 180° about a central axis of the second body 402.

In an embodiment, the first half 404 of the second body 402 can include a first end plate 408 and a second end plate 410. The first end plate 408 can generally include a wall 412 defining a first side 414 and a second side 416. A projection 418 can extend from the second side 416 of the wall 412. In an embodiment, the projection 418 defines a tapered shape, such as a conical shape, or even a frustoconical shape. A distal end of the projection 418 can include an opening 420 through which a cable C extends.

The second end plate 410 can generally include a wall 422 defining a first side 424 and a second side 426. A projection 428 can extend from the second side 426 of the wall 422. In an embodiment, the projection 428 defines a tapered shape, such as a conical shape, or even a frustoconical shape. A distal end of the projection 428 can include an opening 430 through which the cable C extends. A sidewall 432 can extend along at least a portion of a radially outer end 434 of the wall 422. In an embodiment, the sidewall 432 includes a first portion 432A extending from the first side 424 and a second portion 432B extending from the second side 426 of the sidewall 432. In an embodiment, a spring seat 436 can be defined by the second end plate 410. The spring seat 436 can provide a support surface against which a spring 438 can bias the second end plate 410.

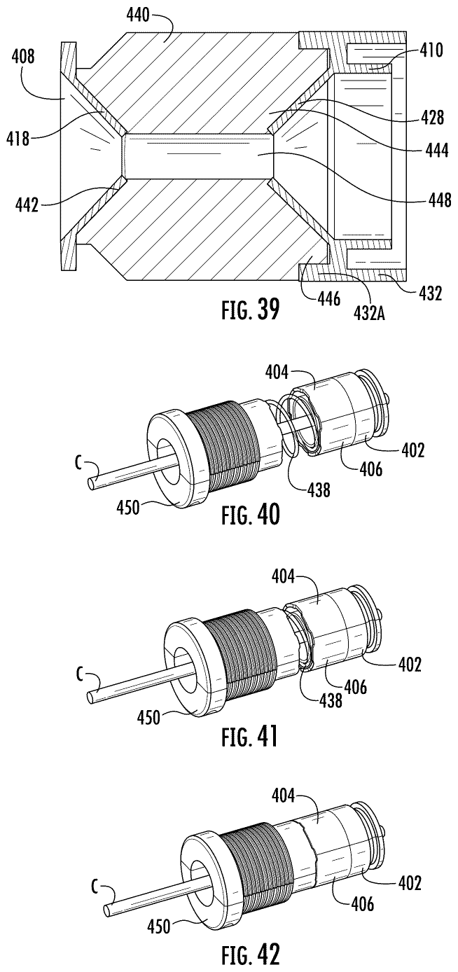

A sealing member 440 can be disposed between the first and second end plates 408 and 410. Referring to FIG. 39, the sealing member 440 can have a shape to accommodate features and geometry of the first and second end plates 408 and 410. For example, the sealing member 440 can include a first tapered end 442 to accommodate the projection 418 of the first end plate 408 and a second tapered end 444 to accommodate the projection 428 of the second end plate 410. The sealing member 440 can further include a circumferentially extending cutout portion 446 to accommodate the first portion 432A of the sidewall 432. An opening 448 can extend through the sealing member 440 and align with the openings 420 and 430 of the first and second end plates 408 and 410. The opening 448 can receive and seal against a cable inserted into the sealing member 440.

Referring again to FIGS. 37 and 38, the spring 438 can be advanced towards the second body 402 by a user engageable element 450. The user engageable element 450 can include, for example, a multi-piece threaded component which is threadably engageable with the first body 390. The multi-piece threaded component can include, for example, a two-piece assembly including a first component 452 and a second component 454. The first and second components 452 and 454 can be joined together to form a continuous thread 456. In an embodiment, the first and second components 452 and 454 can be joined together at a seam 458. Multi-piece configuration of the user engageable element 450 permits installation of the user engageable element 450 around a cable C without requiring sliding the user engageable element 450 along a length of the cable C. Instead, the user engageable element 450 can be introduced on opposite sides of the cable C via translation in a direction perpendicular to a length of the cable C.

Alignment features 460 (e.g., a projection and corresponding recess to receive the projection) can be disposed along the seam 458 of the first and second components 452 and 454. The alignment features 460 can interact with one another to retain the first and second components 452 and 454 aligned with respect to one another. In some instances, the first and second components 452 and 454 can be further coupled together through use of a fastener, e.g., a threaded fastener. The fastener can be inserted into an opening 453 in the first component 452 and interface with complementary engagement features, e.g., threads in the second component 454.

In an embodiment, the first and second components 452 and 454 can further include a spring groove 462 to receive the spring 438. As the user engageable element 450 is advanced towards the cutout 400, e.g., by threading the thread 456 into a thread 464 of the first body 390, the spring 438 can be biased by the user engageable element 450 and bias the first and second end plates 408 and 410 together. The wall 412 of the first end plate 410 can interact with a feature, e.g., a groove 466 of the first body 390 (or another portion of the sealing structure 388) to prevent the second body 402 from being pressed through the cutout 400 by pressure exhibited on the second body 402 by the spring 438.

As described in greater detail below, the user engageable element 450 can be threaded, or otherwise biased towards, to the first body 390 to seal the cable C within the cutout 400. A tactile feedback system can inform a user when the user engageable element 450 has compressed the spring 438 and the desired spring force has been achieved. By way of non-limiting example, the tactile feedback system can include a first set of castellations 468 disposed on the user engageable element 450 and a second set of castellations 470 disposed on the second body 402, e.g., on the second end plate 410. As the user threads the user engageable element 450 into the cutout 400 and reaches the desired spring force, the first set of castellations 468 and the second set of castellations 470 interact with one another to provide a tactile indication to the user. By way of non-limiting example, this tactile indication may take the form of an audible sound (e.g., a clicking sound), a physical snap whereby the user engageable element 450 self-turns a final amount of rotation to allow the first and second sets of castellations 468 and 470 to seat relative to one another, or both. In an embodiment, at least one of the first or second sets of castellations 468 or 470 can have rounded or sloped leading or trailing edges such that the castellations ride on one another to engage and disengage.

Referring to FIG. 37, the threads 464 engaged by the user engageable element 450 may not extend around the entire circumference of the cutout 400. In such a manner, the cable C₁ can be laterally translated into the cutout 400. A cap 472 can be insertable into the cutout 400 and can include threads 474 which, together with threads 464, form a continuous thread to receive the threads 456 of the user engageable element 450. The cap 472 can include retention features 476 which interface with complementary retention features 478 on the first body 390 to retain the cap 472 relative to the first body 390. By way of non-limiting example, the retention features 476 can include lipped fingers and the complementary retention features 478 can include grooves which received the lipped fingers to retain the cap 472 relative to the first body 390. By way of another embodiment, the retention feature 476 can include a fastener (e.g., a threaded fastener or a non-threaded fastener) which interfaces with a receiving unit associated with the complementary retention features 478. The user can install the cap 472 by translating the cap 472 into the cutout 400 until the lipped fingers interface with the grooves. A sealing material 480 can be disposed on the end cap 472 and seal with the first body 390, a cover 276 of the enclosure 268 (FIG. 23), or the like.

A method of installing the sealing structure 388 will now be described with reference to FIGS. 40 to 47. Referring initially to FIG. 43, the first half 404 of the second body 402 is first installed within the cutout 400 of the first body 390 by translating the first half 404 in the direction shown by arrow 482. The cable C is then translated laterally into the cutout 400 in the direction shown by arrow 484. With the cable C in position, the second half 406 of the second body 402 is translated into the cutout 400 in the direction shown by arrow 486 and positioned on the cable C.

In another embodiment, the first and second halves 404 and 406 of the second body 402 can first be joined together around the cable C and then translated into the cutout 400 as a unit. In yet another embodiment, the first half 404 can be positioned relative to the cable C before either the first half 404 or cable C is translated into the cutout 400 and the second half 406 can be joined to the first half 404 and cable C after the first half 404 and cable C are translated into the cutout 400.

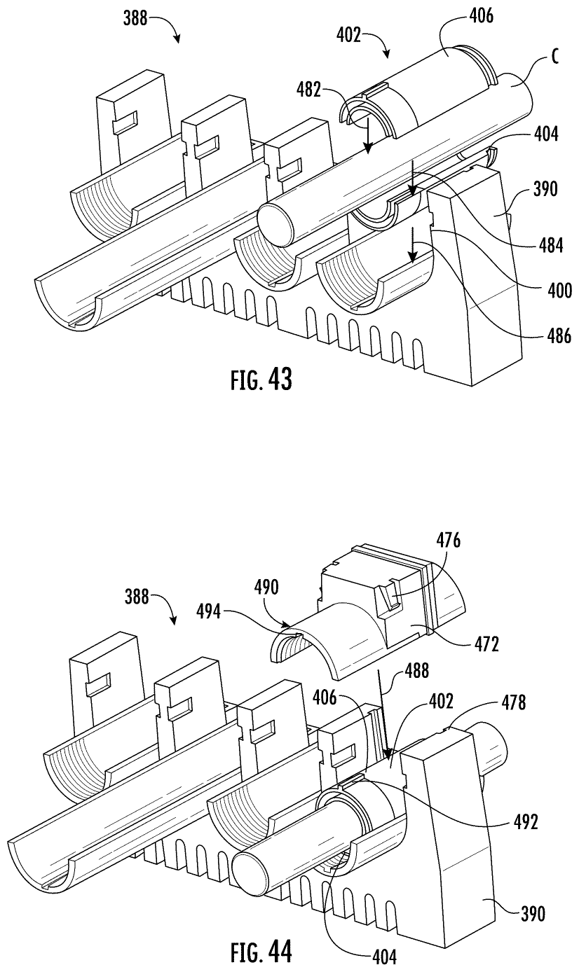

Referring to FIG. 44, the cap 472 can be translated into the cutout 400 in a direction shown by arrow 488 after the second body 402 and cable C are already disposed within the cutout 400. Alternatively, the cap 472 can be translated into the cutout 400 with any one or more of the first half 404 of the second body 402, the cable C, or the second half 406 of the second body 402. The cap 472 is translated into the cutout 400 until the retention features 476 are interfaced with the complementary retention features 478, at which point the cap 472 may be locked to the first body 390 as depicted in FIG. 45.

Referring again to FIG. 44, the cap 472 (or another component of the sealing structure 388) can include an anti-rotation feature 490 to prevent relative rotation between the first and second bodies 390 and 402, between the second body 402 and the cap 472, or both. The anti-rotation feature 490 depicted in FIG. 44 includes a projection 492 extending from the second body 402 and a complementary groove 494 extending into the cap 472. In another embodiment, the anti-rotation feature 490 can include a groove extending into the second body 402 and a complementary projection projecting from the cap 472. In yet another embodiment, the groove and projection can be part of different structures of the sealing structure 388. In yet a further embodiment, the anti-rotation feature 490 can include a different arrangement, such as a flattened section of a circumference of the second body 402 and the cap 472 or the second body 402 and the first body 390 which align with one another and prevent relative rotation therebetween. The anti-rotation feature 490 can prevent the cable C from twisting or deflecting when load is applied to it, e.g., during initial wiring operations when the enclosure 268 (FIG. 23) is being set up and the cables are being operated on and routed throughout the enclosure 268.

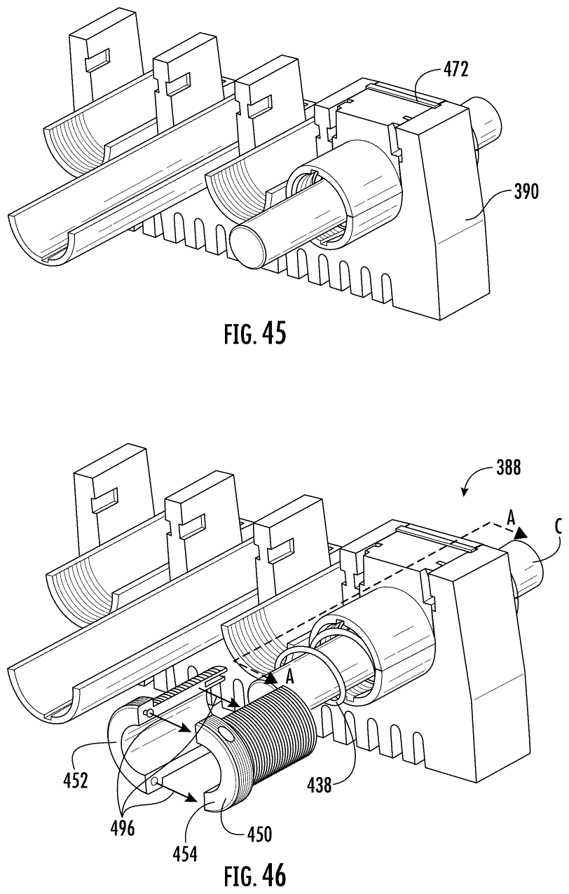

FIG. 46 illustrates the sealing structure 388 after the spring 438 is installed around the cable C. With the spring 438 in position, the user engageable element 450 can be installed around the cable C by bringing together the first and second components 452 and 454 as shown by arrows 496.

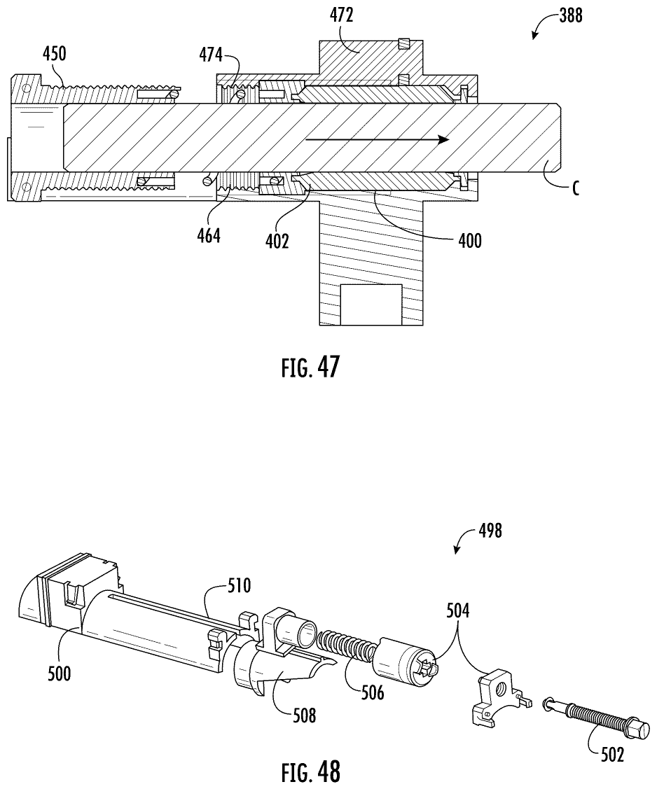

FIG. 47 illustrates a cross-sectional view of the sealing structure 388 as seen along Line A-A in FIG. 46 after the user engageable element 450 is installed around the cable C. As depicted in FIG. 47, the threads 464 and 474 can form an interference fit with the second body 402 once the cap 472 is installed in the cutout 400. That is, portions of the threads 464 and 474 adjacent to the second body 402 can define a diameter less than an outer diameter of the second body 402, and more particularly less than an outer diameter of the second end plate 410 of the second body 402, such that the second body 402 cannot be removed from the sealing structure 388. With the arrangement shown in FIG. 47, the user can thread the user engageable element 450 onto the threads 464 and 474 until the tactile indication is received. At such time, the cable C is sealed relative to the sealing structure 388.

FIGS. 40 to 42 illustrate the second body 402, the user engageable element 450 and the spring 438 as they undergo tightening. FIG. 40 illustrates the components as seen when the user engageable element 450 is initially installed, i.e., immediately prior to threading the user engageable element 450 onto the threads 464 and 474. FIG. 41 illustrates the components as seen when the user engageable element 450 is partially installed, i.e., during the threading operation. FIG. 42 illustrates the components as seen when the user engageable element 450 is fully seated relative to the second body 402 such that the seal relative to the cable C is completed.

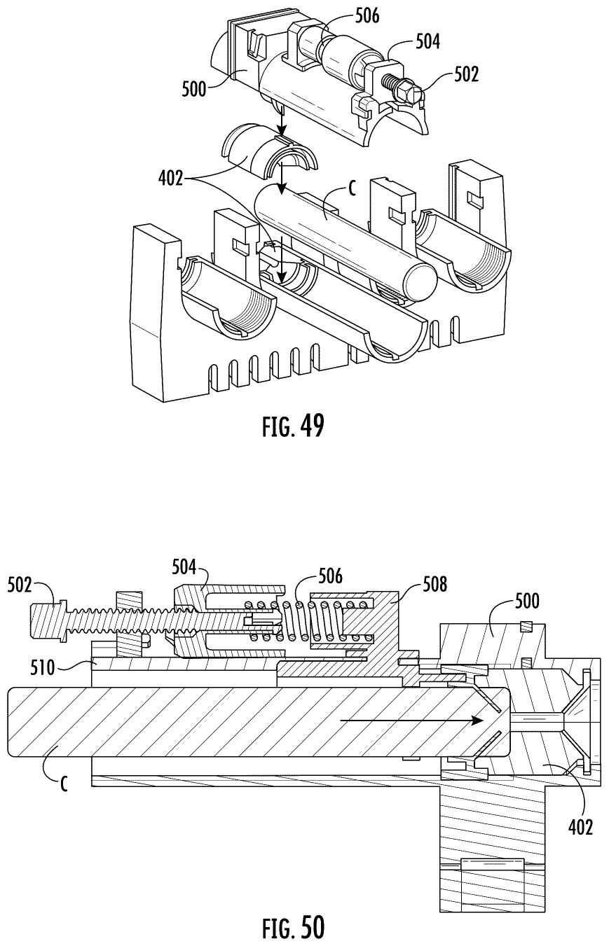

FIGS. 48 to 50 illustrate an embodiment of a sealing structure 498 substantially similar in operation to the sealing structure depicted in FIGS. 37 to 47. However, instead of the inline arrangement of components (e.g., the spring 438, the user engageable element 450, etc.) the arrangement depicted in FIGS. 48 to 50 includes components laterally offset from the centerline of the cable C. The second body 402 depicted in FIGS. 37 to 47 may remain as previously described, however, a carrier 500 is used to carry a user engageable element 502 which drives a driven element 504 to bias a spring 506 into a transfer element 508 that transfers force to the second body 402. The transfer element 508 extends through the carrier 500 (or around the carrier 500) and biases the second body 402 to the compressed state as described above with respect to the embodiment depicted in FIGS. 37 to 47. In an embodiment, the carrier 500 can be similar to the aforementioned cap 472. However, the carrier 500 can include an elongated portion 510 to support the aforementioned components utilized to compress the second body 402.

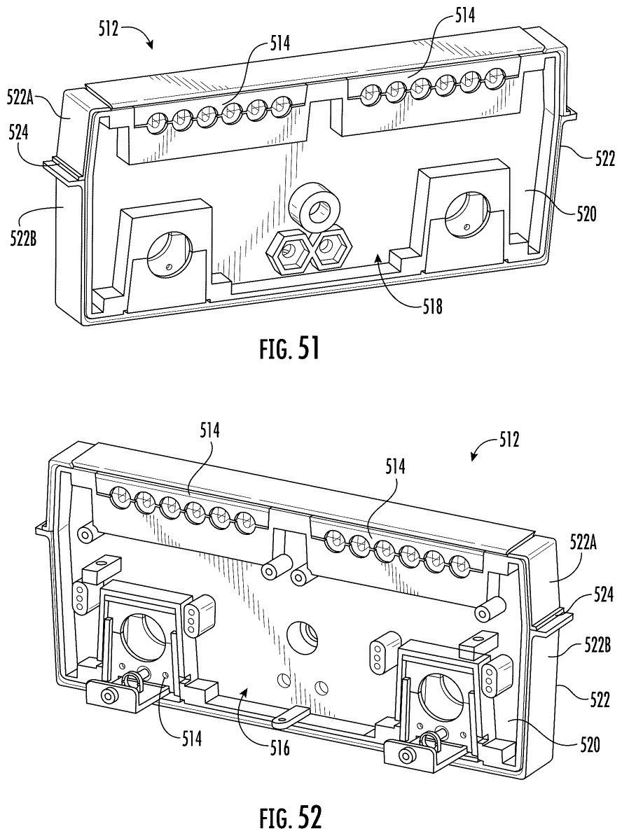

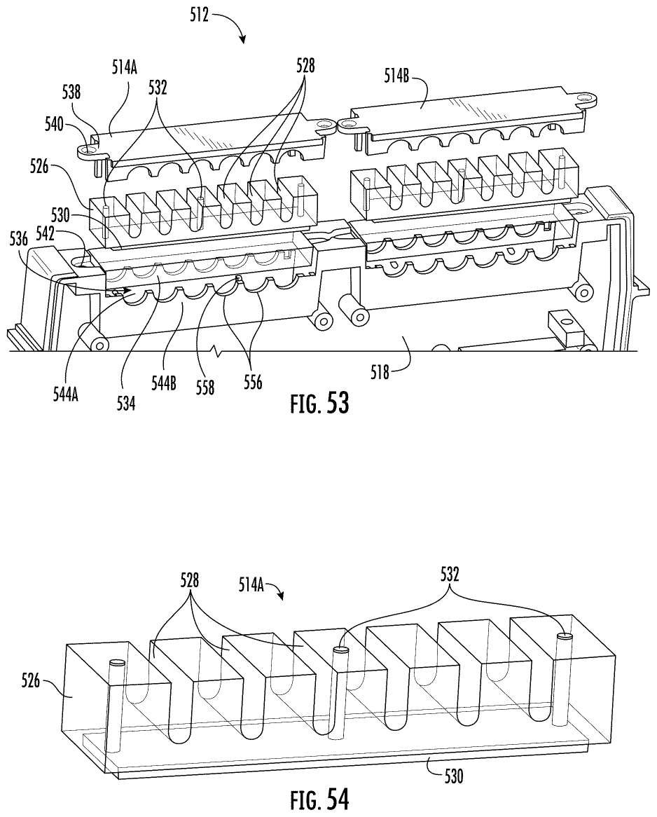

FIGS. 51 to 54 illustrate a sealing structure 512 in accordance with yet another embodiment. In particular, FIG. 51 illustrates the sealing structure 512 as seen from an external position outside of the enclosure, FIG. 52 illustrates the sealing structure 512 as seen from an internal position inside the enclosure, FIG. 53 illustrates an exploded view of the sealing structure 512, and FIG. 54 illustrates a view of a sealing assembly 514 for use with the sealing structure 512.

Referring initially to FIGS. 51 and 52, the sealing structure 512 can generally define an internal surface 516 and an external surface 518. The internal surface 516 can face an internal volume of the enclosure and the external surface 518 can face an external environment when the sealing structure 512 is disposed in the enclosure. The sealing structure 512 can generally include one or more sealing assemblies 514 to seal one or more optical cables entering or exiting the enclosure. In some instances, at least one of the sealing assemblies 514 can be configured to seal a plurality of optical cables. In other instances, at least one of the sealing assemblies 514 can be configured to seal a single optical cable. In yet other instances, at least one of the sealing assemblies 514 can be configured to seal a single optical cable while another of the sealing assemblies 514 is configured to seal a plurality of optical cables.

As depicted in FIGS. 51 and 52, the sealing structure 512 can include a first body 520 and a second body 522. In an embodiment, the first body 520 can be formed from a first material and the second body 522 can be formed from a second material different from the first material. By way of non-limiting example, the first material can include a rigid material, such as a plastic, and the second material can include a deformable material, such as a rubber or gel. The second body 522 can be disposed around at least a portion of a perimeter of the first body 520. In this regard, the second body 522 can form a sealed interface relative to a housing and cover of the enclosure (such as for example, the housing 274 and cover 276 of enclosure 268 illustrated in FIG. 23). In an embodiment, the second body 522 can include a plurality of segments disposed adjacent to one another. For example, the second body 522 can include a first portion 522A and a second portion 522B which meet at an interface 524. In the illustrated embodiment, the interface 524 is formed by flanged ends of each of the first and second portions 522A and 522B which meet to seal the sealing structure 512.

FIG. 53 illustrates the sealing structure 512 with the sealing assemblies 514 (and more particularly first and second sealing assemblies 514A and 514B) shown in a non-engaged configuration whereby an optical cable is not actively sealed. The following description is made with respect to the first sealing assembly 514A, however it should be understood that any one or more of the features or attributes as described with respect to the first sealing assembly 514A may also be included on the second sealing assembly 514B.

As shown in FIGS. 53 and 54, the first sealing assembly 514A comprises a sealing block 526 defining a plurality of grooves 528 each configured to receive a fiber optic cable. By way of example, the plurality of grooves 528 can include at least two grooves, such as at least three grooves, such as at least four grooves, such as at least five groove, such as at least ten grooves. The grooves 528 can all extend in a generally parallel direction with respect to one another. The sealing block 526 can be formed from a deformable material, such as a gel or rubber. Accordingly, each one of the grooves 528 can deform to accommodate the shape of the fiber optic cable received in the groove 528.

The sealing block 526 can be coupled to a support member 530. The support member 530 can be more rigid than the sealing block 526 and support against deflection of the sealing block 526. As depicted, the support member 530 can be disposed adjacent to the sealing block 526. For example, the support member 530 can rest against a surface of the sealing block 526. In an embodiment, the support member 530 can include one or more projections 532 extending from a planar surface 534 of the support member 530. The projections 532 can extend into the sealing block 526. In some instances, the projections 532 can terminate within the sealing block 526. That is, the projections 532 may not extend fully through the sealing block 526. In other instances, the projections 532 can extend through the sealing block 526. In an embodiment, the projections 532 can be engaged with the sealing block 526. The projections 532 may be configured to support the deformable material of the sealing block 526 to prevent the sealing block 526 from flowing out of the sealing structure 512. In an embodiment, the projections 532 can be spaced apart from one another by a plurality of grooves 528. For example, each adjacent set of projections 532 can be spaced apart by two grooves 528, three grooves 528, etc. In another embodiment, the projections 532 can be spaced apart from one another by a single groove 528. In yet another embodiment, a plurality of projections 532 can be disposed between adjacent grooves 528.

A secondary sealing block 534 can be disposed between the first body 518 and the support member 530. In an embodiment, the secondary sealing block 534 can be formed from the same material as the sealing block 526. In another embodiment, the secondary sealing block 534 can be formed from a different material than the sealing block 526. In an embodiment, secondary sealing block 534 can rest against the support member 530 and seal between the support member 530 and the first body 518. By way of non-limiting example, the secondary sealing block 534 can have a generally cubic shape. More particularly, the secondary sealing block 534 can have a generally rectangular cubic shape. During assembly of the sealing structure 512, the secondary sealing block 534 is positioned within a receiving area 536 of the first body 518. The support member 530 is then introduced into the receiving area 536, optionally with the sealing block 526. After one or more fiber optic cables are installed within the grooves 528, a cover 538 is positioned over the sealing block 526. The cover 538 may fit at least partially within the receiving area 536. Openings 540 can receive fasteners (not illustrated) which are received in engagement structures, e.g., openings 542, of the first body 518. Alternatively, or in addition, the cover 528 be coupled to the first body 518 by a snap fit interface including integrated or external snap fit components, or through another connection method.

As shown in FIG. 53, the receiving area 536 can be defined by sidewalls 544A and 544B of the first body 518. The sidewalls 544A and 544B can form a pocket in the first body 518. The pocket can have a size and shape to receive the sealing assembly 514A. In an embodiment, at least one of the sidewalls 544A or 544B, such as both of the sidewalls 544A and 544B, can have a scalloped upper end (as shown in the orientation in FIG. 53). The scalloped upper end(s) can include recesses 546 which align with the grooves 528 to allow the fiber optic cable to pass through the sealing structure 512.

In an embodiment, the pockets, e.g., one or both of the sidewalls 544A or 544B can define a retention feature 558. By way of non-limiting example, the retention feature 558 can project into the receiving area 536 and retain one or more components of the sealing assembly 514A within the receiving area 536. For example, the retention feature 558 can include an edge or surface configured to interface with the sealing block 526. The edge or surface can extend into the sealing block 526 and grip the sealing block 526 to prevent the sealing block 526 from pulling out of the receiving area 536 even when the cover 538 is removed. In some instances, the retention feature 558 can include a plurality of retention features, such as at least two retention features, at least three retention features, at least four retention features, etc. The plurality of retention features 558 can be spread around the receiving area 536 to interface with the sealing assembly 514A at various different locations. In another embodiment, the retention feature 558 can include an elongated interface which extends along a length of the sealing assembly 514A. For example, the elongated retention feature 558 can include a ridge extending along a majority of the receiving area 536. The ridge can project into the receiving area 536 and interface with one or more components of the sealing assembly 514A to retain the sealing assembly 514A, or a portion thereof, in the receiving area 536.

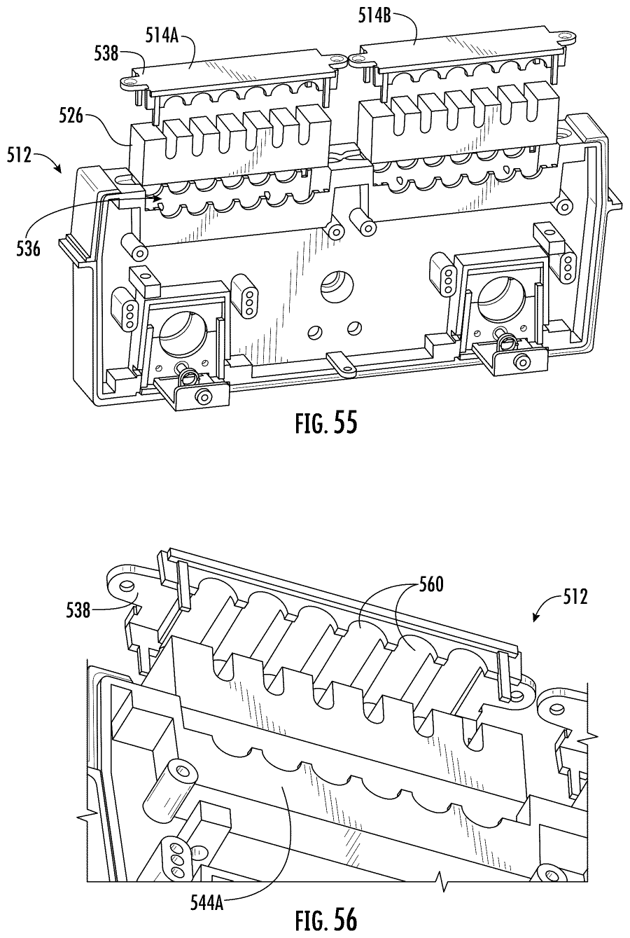

FIGS. 55 and 56 illustrate an embodiment of the sealing system 512 without the support member 530 and without the secondary sealing block 534. In this embodiment, the sealing block 526 is disposed between and directly contacts both the cover 538 and the entire, or substantially entire, receiving area 536. As shown in FIG. 56, the cover 538 can define one or more scalloped surfaces 560 which interface with the fiber optic cables to aid in sealing. The scalloped surfaces 560 can align with the scalloped upper end of the sidewalls 544A to allow the fiber optic cable to pass through the sealing structure 512.

Embodiments described herein are generally directed to enclosures for telecommunication networks. In particular embodiments, the telecommunication networks can include fiber optic cables which are routed through the enclosures. In other embodiments, other types of cables can be used with the enclosure in combination or separate form fiber optic cables. Other exemplary cable types include coaxial cable, category 5 cable, category 6 cable, cat 8 cable, ethernet cable, class F cable, electrical cable, or the like. In some instances, the enclosure can simultaneously house different types of cables or can be retrofit between different types of cables.

Enclosures described herein advantageously provide for effective sealing to mitigate environmental contamination while also affording ease of use and adaptability for in-field installation and setup. The embodiments described herein can be combined with one another and modified with each other such that any aspects described with respect to any one of the sealing structures or its components can be used with any other one of the sealing structures or its components.

In certain instances, plugs or blanks can be used with some of the sealing structures, and more particularly the second bodies, when no cable is present therethrough. For example, in some instances, the enclosure can house 12 cables but only some of the 12 cable receptacles are occupied. The others of the cable receptacles, e.g., the second bodies not presently holding a cable, can receive one or more plugs or blanks to prevent ingress of water into the enclosure.

Various different embodiments of seal receptacles are described herein. In some instances, each enclosure can include all of a single, common type of receptacle. For instance, all sealing receptacles, e.g., all of the second bodies, can be formed from a same type of design. In another instance, the enclosure can simultaneously utilize sealing bodies having different constructions. For example, one cable can be sealed using a first type of receptacle, e.g., second body, and another cable can be sealed using a second type of receptacle, e.g., second body. Yet further, another cable can be sealed using a third type of receptacle, e.g., a third body.

Further aspects of the invention are provided by one or more of the following embodiments:

Embodiment 1. A sealing structure for an enclosure, the sealing structure comprising: a first body defining a plurality of cutouts; and a plurality of second bodies, each of the plurality of second bodies disposed in one of the plurality of cutouts, wherein each of the second bodies comprises: a first half including a sealing member disposed between a first end plate and a second end plate; and a second half including a sealing member disposed between a first end plate and a second end plate, wherein the sealing member of a first half of one second body abuts the sealing member of a second half of another second body, and wherein each of the plurality of second bodies is configured to seal a fiber optic cable entering or exiting the enclosure.

Embodiment 2. The sealing structure of embodiment 1, wherein the first end plate of the first half comprises a wall defining an opening and a channel, and wherein the sealing member extends through the opening from a first side of the wall to the channel on a second side of the wall.

Embodiment 3. The sealing structure of any one of the preceding embodiments, wherein the second end plate of the first half defines an opening and a channel, and wherein the sealing member extends through the opening from a first side of the wall to the channel on a second side of the wall.

Embodiment 4. A sealing structure comprising: a first end plate; a second end plate; and a sealing member disposed between the first and second end plates, wherein at least one of the first and second end plates comprises a wall having a first side, a second side, and an opening extending between the first and second sides, wherein the sealing member extends through the opening from the first side of the wall to a channel disposed in a second side of the wall so as to fill the channel, and wherein the sealing member is fixedly coupled to the wall by the portion of the sealing member extending through the opening and into the channel.

Embodiment 5. The sealing structure of any one of the preceding embodiments, wherein each of the plurality of cutouts defines a dimension, wherein each of the second bodies has an unbiased dimension, and wherein the unbiased dimension is greater than the dimension of the plurality of cutouts.

Embodiment 6. The sealing structure of any one of the preceding embodiments, wherein each of the second bodies is retained in one of the plurality of cutouts in a state of compression, and wherein the compression is created by forces applied on the first and second end plates by the first body.

Embodiment 7. The sealing structure of any one of the preceding embodiments, wherein the first end plate of the first half of at least two adjacent second bodies comprises a tongue, wherein the first end plate of the second half of the at least two adjacent second bodies comprises a groove, and wherein the tongue and groove are interfaced together when the two adjacent second bodies are disposed within neighboring cutouts of the plurality of cutouts.

Embodiment 8. The sealing structure of any one of the preceding embodiments, wherein the first and second end plates of the first half float relative to one another.

Embodiment 9. The sealing structure of any one of the preceding embodiments, wherein the first end plate of each of the first and second halves comprises a projection, and wherein the projections of the first end plates together form a cable passageway, the cable passageway defining one or more cable engagement surfaces to retain the fiber optic cable at a relatively fixed position with respect to the cable passageway.

Embodiment 10. The sealing structure of any one of the preceding embodiments, wherein the first and second halves are arranged for sealing by translating the first and second halves towards one another from substantially opposite lateral sides of the fiber optic cable.

Embodiment 11. The sealing structure of any one of the preceding embodiments, wherein the sealing members are not visible from a location external to the enclosure when the enclosure is in the closed configuration.

Embodiment 12. The sealing structure of any one of the preceding embodiments, wherein the enclosure comprises a housing and a cover, the cover comprising a first cover portion and a second cover portion, wherein the second cover portion is moveable relative to the first cover portion, and wherein at least some of the second bodies contact the second cover portion when the enclosure is in the closed configuration.

Embodiment 13. The sealing structure of embodiment 12, wherein the second cover portion is configured to impart a force on the at least some second bodies when the enclosure is in the closed configuration, and wherein the force imparted by the second cover portion on the at least some second bodies seals at least one of the second bodies around the fiber optic cable extending through that second body.

Embodiment 14. The sealing structure of any one of embodiments 12 or 13, wherein the second cover portion comprises a sealing material disposed at a location to interact with the sealing structure when the enclosure is in the closed configuration.

Embodiment 15. The sealing structure of any one of embodiments 12-14, wherein the housing further comprises a sealing material disposed at a location to interact with the sealing structure when the enclosure is in the closed configuration.

Embodiment 16. The sealing structure of any one of embodiments 12-15, wherein the housing defines an area that receives the sealing structure, and wherein the area is defined by a first flange and a second flange, the first and second flanges being part of the housing.

Embodiment 17. The sealing structure of any one of the preceding embodiments, wherein the cutouts are arranged on a first side of the first body, and wherein the sealing structure further comprises a plurality of second cutouts arranged on a second side of the first body, the second side being opposite the first side.

Embodiment 18. The sealing structure of embodiment 17, wherein each of the plurality of second cutouts is larger than each of the plurality of cutouts.

Embodiment 19. The sealing structure of any one of embodiments 17 or 18, wherein each of the plurality of second cutouts is configured to receive a second body having a size larger than a size of the second bodies received in the plurality of cutouts.

Embodiment 20. The sealing structure of any one of the preceding embodiments, wherein the enclosure comprises an internal volume, wherein a patch panel is disposed within the internal volume, the patch panel being disposed between a main region of the enclosure and a support region of the enclosure, and wherein the patch panel prevents access to the main region of the enclosure when the enclosure is in a semi-open configuration.

Embodiment 21. A method of sealing an enclosure receiving a fiber optic cable, the method comprising: forming a sealing structure, wherein forming the sealing structure is performed by: providing a first body; forming a second body configured to receive the fiber optic cable, wherein forming the second body comprises translating a first half of the second body and a second half of the second body together; and inserting the second body into a receiving area of the first body; inserting the sealing structure into a housing of the enclosure; and closing a cover of the enclosure to compress the sealing structure and seal the fiber optic cable.

Embodiment 22. The method of embodiment 22, wherein the second body comprises a first end plate, a second end plate, and a sealing member disposed between the first and second end plates, and wherein forming the sealing structure further comprises compressing together the first and second end plates prior to inserting the second body into the receiving area.

Embodiment 23. The method of any one of embodiments 21 or 22, wherein inserting the second body into the receiving area comprises inserting a plurality of second bodies into a plurality of receiving areas of the first body.

Embodiment 24. The method of any one of embodiments 21-23, wherein the cover comprises a first cover portion and a second cover portion, wherein the first cover portion is coupled to a housing, wherein the second cover portion is moveable relative to the first cover portion, and wherein closing the cover is performed by closing the second cover portion relative to the first cover portion.

Embodiment 25. The method of any one of embodiments 21-24, wherein inserting the second body into the receiving area is performed by aligning a tongue on the second body with a groove of an adjacent second body and translating the second body into the receiving area.

Embodiment 26. The method of embodiment 25, wherein translating the second body into the receiving area comprises translating the second body along the adjacent second body.

Embodiment 27. A sealing structure for an enclosure receiving a fiber optic cable, the sealing structure comprising: a first body comprising a pair of fingers defining a slot; a second body disposed at the slot and defining a cutout to receive the fiber optic cable within the cutout; a plug insertable into the cutout when the fiber optic cable is not present in the cutout, wherein the plug comprises: a first member; a second member; and a third member disposed between the first and second members, wherein the first, second and third members are separable from one another, and wherein an effective diameter of the plug is selectable based on which of the first, second and third members are present.

Embodiment 28. The sealing structure of embodiment 27, wherein the third member comprises a gel.

Embodiment 29. The sealing member of any one of embodiments 27 or 28, wherein the first and second members each comprise a relatively rigid material.

Embodiment 30. The sealing member of any one of embodiments 27-29, wherein each of the first, second and third members comprise an elongated member, and wherein the elongated members are configured to extend through the cutout when the plug is installed at the cutout.

Embodiment 31. The sealing member of embodiment 30, wherein at least one of the elongated members is hollow.

Embodiment 32. The sealing member of any one of embodiments 30 or 31, wherein at least one of the elongated members defines an open end.

Embodiment 33. The sealing member of any one of embodiments 30-32, wherein the first and second members define a cross section having a pointed oval shape.

Embodiment 34. The sealing member of any one of embodiments 30-33, wherein the elongated member of the third member defines a rounded hourglass shape defining a plurality of cutouts, and wherein the elongated members of each of the first and second members are positionable in one of the plurality of cutouts.

Embodiment 35. The sealing member of any one of embodiments 30-33, wherein the plug defines a circular cross section when all of the first, second and third members are present.

Embodiment 36. The sealing member of any one of embodiments 27-35, wherein the first member comprises an end cap, and wherein the end cap is configured to prevent overinsertion of the plug relative to the cutout.

Embodiment 37. The sealing member of any one of embodiments 27-36, wherein the first and second members comprise an alignment feature to align the first and second members relative to one another.

Embodiment 38. The sealing member of embodiment 37, wherein the alignment feature comprises a projection on one of the first and second members and a recess on the other of the first and second members, the projection being receivable in the recess to align the first and second members relative to one another.

Embodiment 39. A method of sealing a cutout in a sealing system for an enclosure configured to receive a fiber optic cable when the fiber optic cable is less than an entire dimension of the cutout, the method comprising: determining a size of the fiber optic cable to be received in the cutout; configuring a plug between two or more different states in view of the determined size, each state being associated with a different cross-sectional size of the plug; installing the plug in the cutout with the fiber optic cable; and closing the enclosure to seal the cutout around the fiber optic cable.

Embodiment 40. The method of embodiment 39, wherein configuring the plug comprises selecting between two or more members of the plug an appropriate configuration of the two or more members.

Embodiment 41. The method of embodiment 40, wherein the two or more members comprise a first member, a second member and a third member, wherein the third member is disposable between the first and second members, and wherein the third member comprises a gel.

Embodiment 42. The method of embodiment 41, wherein the first and second members have cross sections with pointed oval shapes.

Embodiment 43. The method of any one of embodiments 41 or 42, wherein the third member comprises an hourglass shape.

Embodiment 44. The method of any one of embodiments 40-43, wherein configuring the plug comprises aligning the two or more members using an alignment feature disposed on at least one of the two or more members.

Embodiment 45. The method of any one of embodiments 40-44, wherein at least two of the two or more members comprise a different shape as compared to one another, and wherein configuring the plug is performed in view of the determined size of the fiber optic cable and the different shapes of the at least two of the two or more members.

Embodiment 46. A sealing structure for an enclosure receiving a fiber optic cable, the sealing structure comprising: a first body defining a cutout; a second body receivable in the cutout, wherein the second body comprises a first end plate, a second end plate, and a sealing member disposed between the first and second endplates; and a user engageable element configured to selectively bias the first and second end plates together when the user engageable element is threaded to the cutout at a threaded interface.

Embodiment 47. The sealing structure of embodiment 46, wherein the first and second end plates each define a projection having a tapered shape.

Embodiment 48. The sealing structure of any one of embodiments 46 or 47, wherein the first and second end plates are configured to translate together when the user engageable element is threaded to the cutout.

Embodiment 49. The sealing structure of any one of embodiments 46-48,wherein the user engageable element and the second body comprise a tactile feedback system configured to inform a user when the user engageable element is seated.

Embodiment 50. The sealing structure of embodiment 49, wherein the tactile feedback system comprises a first set of castellations on the user engageable element and a second set of castellations on the second body.

Embodiment 51. The sealing structure of embodiment 50, wherein the second set of castellations are disposed on the second end plate.

Embodiment 52. The sealing structure of any one of embodiments 46-51,wherein the user engageable element comprises a multi-piece construction including a first component and a second component, and wherein the first and second components are configured to join together around the fiber optic cable.

Embodiment 53. The sealing structure of embodiment 52, wherein the first and second components are selectively couplable to one another via a fastener inserted into an opening in the first component and interfacing with a complementary engagement feature in the second component.

Embodiment 54. The sealing structure of any one of embodiments 52 or 53, wherein the first and second components are joined together after the fiber optic cable is inserted into the sealing assembly.

Embodiment 55. The sealing structure of any one of embodiments 46-54, wherein the second body is retained in the cutout by a cap, and wherein the cap interfaces with the first body to retain the second body in the cutout.

Embodiment 56. The sealing structure of embodiment 55, wherein the cap comprises a plurality of retention features configured to interface with complementary retention features of the first body.

Embodiment 57. The sealing structure of any one of embodiments 55 or 56, wherein the cap comprises threads, and wherein the threads of the cap are configured to align with threads of the first body to form the threaded interface.

Embodiment 58. The sealing structure of any one of embodiments 55-57, wherein the cap comprises a sealing material configured to form a sealed interface with a cover of the enclosure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A sealing structure for an enclosure, the sealing structure comprising:
a first body defining a plurality of cutouts; and
a plurality of second bodies, each of the plurality of second bodies disposed in one of the plurality of cutouts, wherein each of the second bodies comprises:
a first half including a sealing member disposed between a first end plate and a second end plate; and
a second half including a sealing member disposed between a first end plate and a second end plate,
wherein the sealing member of a first half of one second body abuts the sealing member of a second half of another second body, and wherein each of the plurality of second bodies is configured to seal a fiber optic cable entering or exiting the enclosure.

2. The sealing structure of claim 1, wherein the first end plate of the first half comprises a wall defining an opening and a channel, and wherein the sealing member extends through the opening from a first side of the wall to the channel on a second side of the wall.

3. The sealing structure of claim 1, wherein the second end plate of the first half defines an opening and a channel, and wherein the sealing member extends through the opening from a first side of the wall to the channel on a second side of the wall.

4. A sealing structure for an enclosure, the sealing structure comprising:
a first end plate;
a second end plate; and
a sealing member disposed between the first and second end plates,
wherein at least one of the first and second end plates comprises a wall having a first side, a second side, and an opening extending between the first and second sides,
wherein a portion of the sealing member extends through the opening from the first side of the wall to a channel disposed in a second side of the wall so as to fill the channel, and
wherein the sealing member is fixedly coupled to the wall by the portion of the sealing member extending through the opening and into the channel.

5. The sealing structure of claim 1, wherein each of the plurality of cutouts defines a dimension, wherein each of the second bodies has an unbiased dimension, and wherein the unbiased dimension is greater than the dimension of the plurality of cutouts.

6. The sealing structure of claim 1, wherein each of the second bodies is retained in one of the plurality of cutouts in a state of compression, and wherein the compression is created by forces applied on the first and second end plates by the first body.

7. The sealing structure of claim 1, wherein the first end plate of the first half of at least two adjacent second bodies comprises a tongue, wherein the first end plate of the second half of the at least two adjacent second bodies comprises a groove, and wherein the tongue and groove are interfaced together when the two adjacent second bodies are disposed within neighboring cutouts of the plurality of cutouts.

8. The sealing structure of claim 1, wherein the first and second end plates of the first half float relative to one another.

9. The sealing structure of claim 1, wherein the first end plate of each of the first and second halves comprises a projection, and wherein the projections of the first end plates together form a cable passageway, the cable passageway defining one or more cable engagement surfaces to retain the fiber optic cable at a relatively fixed position with respect to the cable passageway.

10. The sealing structure of claim 1, wherein the sealing members are not visible from a location external to the enclosure when the enclosure is in a closed configuration.

11. The sealing structure of claim 1, wherein the enclosure comprises a housing and a cover, the cover comprising a first cover portion and a second cover portion, wherein the second cover portion is moveable relative to the first cover portion, and wherein at least some of the second bodies contact the second cover portion when the enclosure is in a closed configuration.

12. The sealing structure of claim 11, wherein the second cover portion is configured to impart a force on the at least some second bodies when the enclosure is in a closed configuration, and wherein the force imparted by the second cover portion on the at least some second bodies seals at least one of the second bodies around the fiber optic cable extending through that second body.

13. The sealing structure of claim 11, wherein the second cover portion comprises a sealing material disposed at a location to interact with the sealing structure when the enclosure is in a closed configuration.

14. The sealing structure of claim 1, wherein the cutouts are arranged on a first side of the first body, and wherein the sealing structure further comprises a plurality of second cutouts arranged on a second side of the first body, the second side being opposite the first side.

15. The sealing structure of claim 14, wherein each of the plurality of second cutouts is larger than each of the plurality of cutouts, and wherein each of the plurality of second cutouts is configured to receive a second body having a size larger than a size of the second bodies received in the plurality of cutouts.
